(19) United States
(12) Patent Application Publication
(10) Pub. No.: US 2020/0177485 A1
(43) Pub. Date: Jun. 4, 2020

(54) NETWORK TRAFFIC METRICS AND TRENDS FOR INTERNET OF THINGS MANAGEMENT

(71) Applicant: Cisco Technology, Inc., San Jose, CA (US)

(72) Inventors: Mark Stephan Shurtleff, Hayward, CA (US); Jerome Henry, Pittsboro, NC (US); Bart Brinckman, Nevele (BE)

(21) Appl. No.: 16/209,553

(22) Filed: Dec. 4, 2018

(51) Int. Cl. H04L 12/26; H04L 29/08

(52) U.S. Cl. CPC H04L 43/0876; H04L 67/12

(57) ABSTRACT

An IoT management system can determine historical traffic volumes of a plurality of IoT devices over one or more time intervals. The IoT management system can determine historical temporal traffic metrics of the IoT devices over the time intervals. The IoT management system can determine standard deviation information for at least one of the historical traffic volumes or the historical temporal traffic metrics over the time intervals. The IoT management system can determine current traffic volumes of the IoT devices. The IoT management system can determine current temporal traffic volumes of the IoT devices. The IoT management system can present an interface including first information indicative of the current traffic volumes, second information indicative of the current temporal traffic metrics, and third information indicative of at least one of the current traffic volumes or the current temporal traffic metrics relative to the standard deviation information.

### TECHNICAL FIELD

The subject matter of this disclosure relates in general to the field of telecommunications networks, and more particularly, to systems and methods for computing and presenting network traffic metrics and trends for managing Internet of Things (IoT) devices.

### BACKGROUND

The next evolution of the Internet is the ability to connect any object over a communications network (rather than just connecting general purpose computing devices). These objects can include, among other things, lighting; appliances; medical devices; factory equipment; vehicles; cameras; media players (e.g., televisions, set-top boxes, speakers, video game consoles, etc.); heating, ventilating, and air-conditioning (HVAC); windows and window shades and blinds; doors; locks; and so forth. This interconnection of everyday objects over a computer network (e.g., the public Internet, a private wide area network (WAN), etc.) is sometimes referred to as the Internet of Things (IoT). IoT networks can operate within wireless or power-line communication (PLC) networks (sometimes also referred to as Low-Power and Lossy Networks (LLNs), e.g., a class of networks in which both the routers and their interconnects may be constrained). LLN devices may operate under various restrictions, such as limitations on processing, memory, storage, networking, power (e.g., battery, energy code compliance, etc.), and so forth. Their interconnects are sometimes characterized by high loss rates, low data rates, and/or instability. IoT networks can comprise a handful of devices to thousands or even millions of devices, and can support point-to-point traffic (between devices inside the network), point-to-multipoint traffic (from a central control point such as a root node to a subset of devices inside the network), and multipoint-to-point traffic (from devices inside the network towards a central control point). IoT can present new challenges for network and security administration given the potentially vast number of devices to manage in a network; the wide divergence in functionality, access requirements, and network usage between and among different types of IoT devices; and the rapidity with which security breaches and performance degradation of IoT devices can occur to overwhelm administration of the network. Current IoT management platforms may not adequately address these problems of scale, heterogeneity, and responsivity.

### BRIEF DESCRIPTION OF THE FIGURES

To provide a more complete understanding of the present disclosure and features and advantages thereof, reference is made to the following description, taken in conjunction with the accompanying drawings, in which:

FIG. 1 illustrates an example of a network environment in accordance with an embodiment;

FIG. 2 illustrates an example of a cloud-based network controller in accordance with an embodiment;

FIG. 3 illustrates an example of a flow diagram of a process for registering an IoT device to an IoT management system in accordance with an embodiment;

FIGS. 4A-4K illustrate examples of interfaces for a client application of an IoT management system in accordance with an embodiment;

FIG. 5 illustrates an example of a process for computing and presenting network traffic metrics and trends for managing a plurality of IoT devices in accordance with an embodiment; and

FIGS. 6A and 6B illustrate examples of systems in accordance with some embodiments.

### DESCRIPTION OF EXAMPLE EMBODIMENTS

The detailed description set forth below is intended as a description of various configurations of embodiments and is not intended to represent the only configurations in which the subject matter of this disclosure can be practiced. The appended drawings are incorporated herein and constitute a part of the detailed description. The detailed description includes specific details for the purpose of providing a more thorough understanding of the subject matter of this disclosure. However, it will be clear and apparent that the subject matter of this disclosure is not limited to the specific details set forth herein and may be practiced without these details. In some instances, structures and components are shown in block diagram form in order to avoid obscuring the concepts of the subject matter of this disclosure.

### Overview

An IoT management system can determine historical traffic volumes of a plurality of IoT devices over one or more time intervals. The IoT management system can determine historical temporal traffic metrics of the plurality of IoT devices over the one or more time intervals (e.g., throughput, change in throughput, etc.). The IoT management system can determine standard deviation information for at least one of the historical traffic volumes or the historical temporal traffic metrics over the one or more time intervals. The IoT management system can determine current traffic volumes of the plurality of IoT devices. The IoT management system can determine current temporal traffic volumes of the plurality of IoT devices. The IoT management system can present an interface including first information indicative of the current traffic volumes, second information indicative of the current temporal traffic metrics, and third information indicative of at least one of the current traffic volumes or the current temporal traffic metrics relative to the standard deviation information.

### EXAMPLE EMBODIMENTS

Households, businesses, and other organizations are increasingly incorporating IoT devices into their networks for automating home, work, campus, and other environments. For example, a typical campus or enterprise network may comprise a few hundred or a few thousand general purpose computing devices (e.g., servers, desktop computers, laptops, etc.) or mobile computing devices (e.g., tablets, smartphones, wearable devices, etc.), which can mean the network may include tens of thousands or more IoT devices. The proliferation of IoT devices can thus represent substantial growth in the duties and responsibilities of administrators tasked with securing and managing their networks. Solutions currently exist for monitoring and managing general purpose computing devices and mobile computing devices, such as using access control lists (ACLs) or Layer 7 (L7) or application layer filters for prohibiting certain applications from running in the network or preventing access to blocked sites. IoT devices, however, can have different volumes of network traffic or different rates of network traffic (e.g., throughputs, changes in throughputs, latencies, jitter, data loss, errors, etc.) distinct from general purpose computing devices. Monitoring these types of devices at the scale of tens of thousands is beyond the capabilities of current solutions.

Various embodiments of the present disclosure can overcome the above and other deficiencies of the prior art by concurrently presenting current network traffic trends of IoT devices and historical trends one or more standard deviations above a baseline and/or historical trends one or more standard deviations below the baseline for an instant comparison between current trends and historical trends. Unlike prior art systems which require multiple screens to convey the information necessary to administer to managed devices and/or extensive effort by a network administrator to investigate and diagnose anomalous behaviors, various embodiments of the present disclosure automate much of the investigation and diagnosis, present the analysis in a manner to support the scale of IoT, and substantially reduce labor on the part of the network administrator. In some embodiments, the client application may even be capable of running on a general purpose mobile computing device such that, from anywhere in the world, an end user can have immediate access to a wide array of sophisticated tools for IoT management and security. Various other functions and advantages are described and suggested below as may be provided in accordance with the various embodiments.

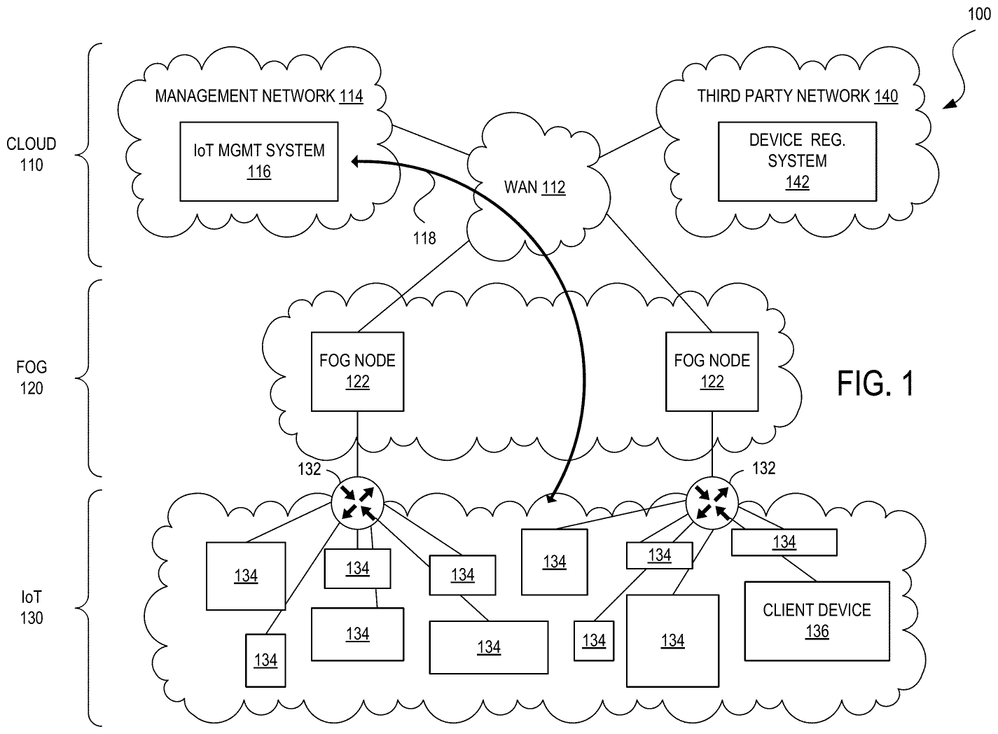

FIG. 1 illustrates an example of a network environment 100 in which the subject technology may be deployed. It should be understood that, for the network environment 100 and any network discussed herein, there can be additional or fewer nodes, devices, links, networks, or components in similar or alternative configurations. Example embodiments with different numbers and/or types of endpoints, networks, nodes, cloud components, servers, software components, devices, virtual or physical resources, configurations, topologies, services, appliances, deployments, or networking devices are also contemplated herein. Further, the network environment 100 can include any number or type of resources, which can be accessed and utilized by endpoints or tenants. The illustrations and examples provided herein are for clarity and simplicity.

In this example, the network environment 100 can comprise multiple layers (also sometimes referred to as clouds or networks), such as a cloud layer 110, a fog layer 120, and an IoT layer 130. The cloud layer 110 may include a wide area network (WAN) 112 (e.g., the Internet or a private IP network), a management network 114 (e.g., third-party public cloud provider, data center, enterprise network, etc.), and a third party network 140. The WAN 112 may connect, directly or indirectly, elements of the cloud layer 110, the fog layer 120, and/or the IoT layer 130. For instance, although the WAN 112, here, connects the management network 114 to the fog layer 120, other embodiments may alternatively or additionally connect the management network 114 directly to the IoT layer 130, connect the management network 114 directly to the fog layer 120, connect the management network 114 to the IoT layer 130 via the WAN 112, connect the fog layer 120 to the IoT layer 130 via the WAN 112, and so forth.

The management network 114 can host an IoT management system 116 for managing and controlling elements of the cloud layer 110, the fog layer 120, and/or the IoT layer 130. The cloud-hosted IoT management system 116 can comprise one or more physical or virtual servers and networking devices (e.g., switches, routers, firewalls, load balancers, etc.) (not shown) that may be configured to manage the configuration and operation of various devices in an intermediate network (e.g., the fog layer 120); a local area network (LAN), such as the IoT cloud 130; and/or across geographically distributed portions of one or more virtual LANs (VLANs). The cloud-hosted IoT management system 116 can manage cloud operations, device communications, service provisioning, network configuration and monitoring, and so forth. The IoT management system 116 can also store configuration information, statistics, monitoring information, and other management data relating to the fog cloud 120 and/or IoT cloud 130. In some implementations, Cisco Jasper® Control Center can operate as the IoT management system 116.

In some embodiments, a secure connection 118 can be established between the management network 114, the fog layer 120, and/or the IoT layer 130, such as via one or more security appliances or other networking devices of the management network 114, the IoT management system 116, the fog cloud 120, and/or the IoT cloud 130. In addition to establishing the secure connection 118, in some embodiments, the security appliances or other networking devices can also provide other services, such as virtual private network (VPN) concentration, firewalling, directory services, certificate authority services, policy management, intrusion detection and prevention, load balancing, WAN acceleration, content filtering, and so forth. The secure connection 118 can be used by devices of the management network 114, the IoT management system 116, the fog cloud 120, and/or the IoT cloud 130 to exchange management data (e.g., configuration, statistical, or monitoring data). The secure connection 118 can be implemented in various ways, such as utilizing VPN or L2 tunneling protocols. In some embodiments, an open VPN (e.g., OpenVPN) overlay or an IP Security (IPSec) VPN-based L3 network extension can be used to provide the secure connection 118. In other embodiments, a secure transport layer (i.e., L4) tunnel can be used as the secure connection 118 between the security appliances 116, such as by utilizing Transport Layer Security (TLS), Datagram TLS (DTLS), Secure Socket Layer (SSL), etc., across the WAN 112.

The secure connection 118 may utilize portions of the WAN 112. For example, packets that are transmitted via the secure connection 118 can be marked and/or contain header fields that enable the prioritization of the secure tunnel packets on at least some portions of the WAN 112. In some embodiments, the prioritization of the secure tunnel packets can include the use of private, dedicated routing paths between the management network 114, the fog cloud 120, and/or the IoT cloud 130 to reduce latency and/or improve reliability.

Fog computing is an example of an approach for cloud computing that can include an intermediate layer between remote centralized and/or shared resources (e.g., the cloud layer 110) and local networks (e.g., the IoT layer 130). That is, fog computing can entail using layers of devices at or near the network edge to provide application services to the local nodes in the network, in contrast to pure cloud-based approaches that rely on remote data centers/cloud environments for the services. To this end, the fog layer 120 can include various fog nodes 122 or functional nodes deployed close to IoT devices (e.g., the IoT devices 134) to provide computing, storage, and networking resources and services. The multiple fog nodes 122 organized or configured together can form a fog system, to implement a particular solution. The fog nodes 122 and/or fog systems can have the same or complementary capabilities, in various implementations. That is, each individual fog node 122 does not have to implement the entire spectrum of capabilities. Instead, the fog capabilities may be distributed across multiple fog nodes 122 and systems, which may collaborate to help each other to provide the desired services. Thus, a fog system can include any number of virtualized services and/or data stores that are spread across the distributed fog nodes 122. This may include a master-slave configuration, publish-subscribe configuration, or peer-to-peer configuration. Resources in the fog layer 120 may be shared between different users, applications, organizations, tenants, or other entities.

The IoT cloud 130 can comprise various devices or nodes, including networking devices 132 (e.g., switches, routers, gateways, network appliances, etc.), IoT devices 134, and a client device 136. In general, the IoT devices 134 can be any object capable of electronically transmitting data to another device over the WAN 112 (directly or indirectly), such as agricultural equipment (e.g., livestock tracking and management systems, watering devices, unmanned aerial vehicles (UAVs), etc.); connected cars and other vehicles; smart home sensors and devices (e.g., alarm systems, security cameras, lighting, appliances, media players, HVAC equipment, utility meters, windows, automatic doors, door bells, locks, etc.); office equipment (e.g., desktop phones, copiers, fax machines, etc.); healthcare devices (e.g., pacemakers, biometric sensors, medical equipment, etc.); industrial equipment (e.g., robots, factory machinery, construction equipment, industrial sensors, etc.); retail equipment (e.g., vending machines, point of sale (POS) devices, WiFi access points, Radio Frequency Identification (RFID) tags, etc.); smart city devices (e.g., street lamps, parking meters, waste management sensors, etc.); transportation and logistical equipment (e.g., turnstiles, rental car trackers, navigational devices, inventory monitors, etc.); and so forth. In some embodiments, the IoT devices 134 can also include general purpose computing devices (e.g., servers, desktops, or laptops, etc.) or general purpose mobile computing devices, such as tablets, smartphones, wearable devices (e.g., watches, glasses or other head-mounted displays (HMDs), hearing devices, etc.), and so forth.

The IoT devices 134 may communicate using wired (e.g., IEEE 802.3 (Ethernet), PLC, public switched telephone network (PSTN), etc.) or wireless (e.g., 2G or greater generation cellular, Wi-Fi, Bluetooth® Low Energy (BLE), ZigBee®, Z-Wave®, Narrowband-IoT (NB-IoT), Near Field Communications (NFCTM), RFID, etc.) technologies. The IoT devices 134 can also utilize protocols across higher layers of the network stack (e.g., the Open Systems Interconnection (OSI) model, the TCP/IP stack, etc.), such as Transmission Control Protocol (TCP)/Internet Protocol (IP), User Datagram Protocol (UDP), Hypertext Transfer Protocol (HTTP), Message Queuing Telemetry Transport (MQTT), Constrained Application Protocol (CoAP), Extensible Messaging and Presence Protocol (XMPP), Data Distribution Service (DDS), Advanced Message Queuing Protocol (AMQP), and so forth. Each of the IoT devices 134 can include one or more processors, one or more types of memory, a display and/or other user interface components such as a keyboard, touch screen display, mouse, track-pad, digital camera, and/or any number of peripheral devices or components to add functionality to each IoT device. The IoT devices 134 can also be capable of protocol processing, modulation, demodulation, data buffering, power control, routing, switching, clock recovery, amplification, decoding, and/or error control.

The IoT cloud 130 can also include a client device 136 to enable an end user to interface with the IoT management system 116 to manage the IoT devices 134 and/or the client device itself. Although the client device 136 is shown here as located in the IoT cloud 130, it will be understood by one of ordinary skill in the art that the client device 136 can be located anywhere so long as the device can connect to the IoT management system 116 (e.g., via the WAN 112). In addition, the client device 136 can itself be considered to be an IoT device and/or can be managed by the IoT management system 116. The client device 136 can include software (e.g., a web browser, a standalone application or app, a shell program, etc.) to interact with the IoT management system 116 as discussed further below.

The third party network 140 can provide various third-party content and services, such as hardware, firmware, and/or software upgrades; network security services; media content (e.g., audio for devices with microphones, video for devices with cameras, etc.); and so forth. In this example, the third party network 140 can include a device registration system 142 for registering the networking devices 132, the IoT devices 134, and/or the client device 136, and identifying the level of access to the network environment 100 the devices may need to operate. An example of an implementation of the registration process is discussed further below.

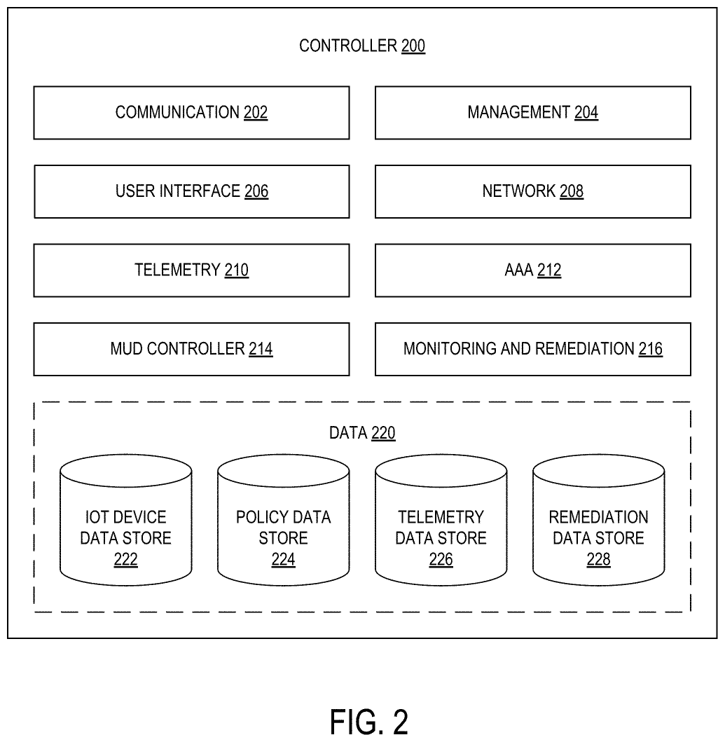

FIG. 2 illustrates an example of a cloud-based network controller 200 for managing and controlling elements of a management network (e.g., the management network 114), an IoT management system (e.g., the IoT management system 116), a fog network (e.g., the fog cloud 120), and/or one or more private LANs or VLANs (e.g., the IoT cloud 130). One of ordinary skill in the art will understand that, for the network controller 200 and any system discussed in the present disclosure, there can be additional or fewer component in similar or alternative configurations. The illustrations and examples provided in the present disclosure are for conciseness and clarity. Other embodiments may include different numbers and/or types of elements but one of ordinary skill the art will appreciate that such variations do not depart from the scope of the present disclosure.

In this example, the network controller 200 can be remotely hosted in a management network (e.g., the management network 114) for managing and controlling networking devices (e.g., the networking devices 132) and/or endpoints (e.g., the fog nodes 122, the IoT devices 134, the client device 136, etc.) for customers of the provider of the management network. The network controller 200 can manage various cloud services, such as provisioning cloud resources in the management network, configuring and updating the cloud resources, monitoring the cloud resources, implementing high availability and failover for the cloud resources, enforcing security and compliance for the cloud resources, and so forth. The network controller 200 can also send network data to and receive network data from devices to facilitate configuration of devices; track the private network and status information of elements of the private network, such as a secure connection (e.g., the secure connection 118), networking devices, and endpoints, among other elements; and administer the private network and the elements of the private network.

The network controller 200 can include several components or modules, such as a communication subsystem 202; a management subsystem 204; a user interface subsystem 206; a network subsystem 208; a telemetry subsystem 210; an authentication, authorization, and accounting (AAA) subsystem 212; a manufacturer usage description (MUD) controller 214, a monitoring and remediation subsystem 216, and a data subsystem 220. These modules may be implemented as hardware, firmware, and/or software. Although FIG. 2 illustrates an example configuration of the various components of the network controller 200, one of skill in the art will understand that the components of network controller 200 or any device described herein can be configured in a number of different ways and can include any other type and number of components. For example, the management subsystem 204 and the network subsystem 208 can belong to one software module or multiple separate modules. Other modules can also be combined into fewer components and/or further divided into more components.

The communication subsystem 202 may allow the network controller 200 to communicate with endpoints, as well as any other device or network. The communication subsystem 202 can comprise a network interface card (NIC), and can include wired and/or wireless capabilities. The communication subsystem 202 may allow the network controller 200 to send and receive data from other devices and networks. The network controller 200 can include multiple communications interfaces for redundancy or failover. For example, the network controller 200 can include dual NICs for connection redundancy.

The management subsystem 204 can include logic to perform management operations. For example, the management subsystem 204 can include logic to allow the various components of the network controller 200 to interface and work together. The management subsystem 204 can also include logic, functions, software, and procedures to allow the network controller 200 to perform management, control, and administration of devices in a private network, applications in the private network, services provided to the devices, or any other component or procedure. The management subsystem 204 can include logic to operate the network controller 200 and perform particular services configured by the network controller 200. The management subsystem 204 may also support high availability and initiate, enable, or launch additional servers, virtual machines, containers, or other computing instances for running the network controller 200. In some embodiments, the management subsystem 204 can manage nodes, resources, settings, policies, protocols, communications, and so forth.

The user interface subsystem 206 can support a frontend that an end user can interact with to access or consume cloud services. For instance, the user interface subsystem 206 can be implemented within a web application/web server accessible by a web browser or an application/application server accessible by a desktop application, a mobile app, a shell program or other command line interface, an Application Programming Interface (e.g., restful state transfer (REST), Simple Object Access Protocol (SOAP), Service Oriented Architecture (SOA), etc.), and/or other suitable interface in which the end user can configure devices or private networks that are cloud-managed, provide user preferences, specify policies, enter data, review statistics, configure interactions or operations, and so forth. The user interface subsystem 206 may also provide visibility information, such as views of a private network or devices. For example, the user interface subsystem 206 can provide a view of the status or conditions of the private network, the operations taking place, services, performance, a topology or layout, specific networking devices, protocols implemented, running processes, errors, notifications, alerts, network structure, ongoing communications, data analysis, and so forth.

In some embodiments, the user interface subsystem 206 can interact with client devices via a graphical user interface (GUI) to enable users to monitor a private network, devices, statistics, errors, notifications, and so forth, and make modifications or setting changes through the GUI. The GUI can depict charts, lists, tables, maps, topologies, symbols, structures, or any graphical object or element. In addition, the GUI can use color, font, shapes, or any other characteristics to depict scores, alerts, or conditions. In some embodiments, the user interface subsystem 206 can also handle user or device requests. For example, an administrator or a device can enter a service request through the user interface subsystem 206.

The network subsystem 208 can perform networking calculations, such as network addressing or networking service or operations, such as auto VPN configuration or traffic routing. The network subsystem 208 may also perform filtering functions, switching functions, failover functions, high availability functions, network or device deployment functions, resource allocation functions, messaging functions, traffic analysis functions, port configuration functions, mapping functions, packet manipulation functions, path calculation functions, loop detection, cost calculation, error detection, or otherwise manipulate data or networking devices. In some embodiments, the network subsystem 208 can handle networking requests from other networks or devices and establish links between devices. In some embodiments, the network subsystem 208 can perform queuing, messaging, and protocol operations.

The telemetry subsystem 210 can collect network traffic data across the network and for individual devices in the network. The network traffic data can include information for individual packets (e.g., packet size, source address, source port, destination address, destination port, protocol, etc.) (sometimes also referred to as tuple information); flows (e.g., tuple information, number of packets and aggregate size of packets having the same or similar tuple information, class of service, router/switch interface, packet inter-arrival times, flow start time, flow end time, duration, TCP flags, etc.); bidirectional flows (e.g., flow data for a request/response pair of flows having corresponding tuple information) (sometimes also referred to as connections); and sessions (e.g., multiple bidirectional flows or connections) (sometimes also referred to as calls as in Voice over IP (VoIP) calls); and/or other units of network data at various levels of granularity. The telemetry subsystem 210 can alternatively or additionally capture or compute statistical information (e.g., mean, median, mode, minimum, maximum, standard deviation(s), etc.) and/or other measures of network performance (e.g., bandwidth or capacity, throughput, delay, latency, jitter, data loss and other errors, etc.). The telemetry subsystem 210 can also generate reports from the network traffic data for presentation (e.g., via the user interface subsystem 206) to end users.

In some embodiments, the telemetry subsystem 210 can also collect other information relating to the devices in a network, such as device information (e.g., host name, network address, operating system, CPU usage, disk space, ports, logged users, scheduled jobs, open files, and information regarding files and/or directories stored by a device); application or process information for an application or process generating a particular, packet, flow, or session (e.g., application or process name, identifier, parent process identifier, directory path, CPU utilization, memory utilization, memory address, scheduling information, nice value, flags, priority, status, start time, terminal type, CPU time taken by the application or process, owner, etc.); user information for a user of a device and/or an application or process (e.g., user name, user numeric identifier, user's real name, e-mail address, user's groups, permissions, etc.); virtualization information (e.g., virtual machine (VM) or container orchestration platform and version or build number, configuration information, physical host information, VM or container information, a list of running VMs or containers, tenant user information, etc.); and other device-specific data capable of being captured by the device (e.g., audio if the device includes a microphone, video if the device includes a camera, temperature if the device is a thermostat, etc.).

The AAA subsystem 212 can control access to computer resources, enforce network policies, audit usage, and provide information necessary to bill for services. The AAA subsystem can interact with network access and gateway devices and with databases and directories containing information for IoT devices, end users, policies, billing, and similar information (e.g., to provide authentication, authorization, and accounting services. In some embodiments, the AAA subsystem 212 can utilize Remote Authentication Dial-In User Service (RADIUS) or Diameter to communicate with devices and applications. In some implementations, the Cisco® Identity Services Engine (ISE) can operate as the AAA subsystem 212 and/or the AAA subsystem can be implemented using Cisco® Application Visibility and Control (AVC).

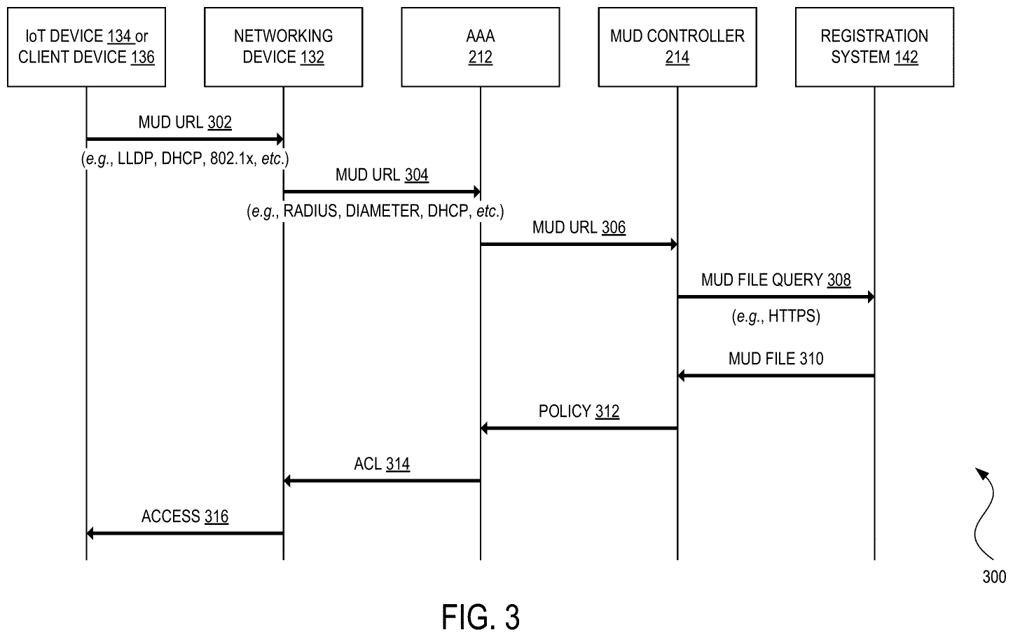

The MUD controller 214 can operate as an interface between the network controller 200 and a device manufacturer's registration system (e.g., the device registration system 142) for registering a device and identifying the types of access the device may need to operate. The process registration may be initiated by an IoT device (e.g., the IoT device 134) or a client device (e.g., the client device 136) registering the IoT device on behalf of the IoT device. For example, in some embodiments, the client device may be a mobile device (e.g., tablet computer, smart phone, smart glasses, etc.) including software (e.g., web browser, mobile app, etc.) for accessing the user interface subsystem 206 or other component of the network controller 200. The software executing on the client device can include a function or feature for capturing the IoT device's serial number, Media Access Control (MAC) address, or other unique identifying information. The unique identifying information may be human-readable or encoded in a machine-readable format (e.g., a Quick Response code (QR Code®) or other matrix bar code, a linear or one-dimensional bar code, etc.). The client device can invoke the registration process on behalf of the IoT device by scanning in the IoT device's unique identifying information. The registration process is discussed further below with respect to FIG. 3.

The monitoring and remediation subsystem 216 can track the status and health of IoT devices to determine whether they are functional and operating within ranges of expected measurements (e.g., upload bandwidth/throughput, download bandwidth throughput, connection rate, etc.) and behaviors (e.g., no payload anomalies; viruses; protocol anomalies, such as MAC/IP address spoofing, duplicate MAC/IP addresses, TCP/IP or UDP fan out, etc.; geographic anomalies (e.g., unusual traffic from certain geographic regions); temporal anomalies (e.g., unusual traffic during certain parts of the day, week, month, year, etc.); user anomalies (e.g., unusual traffic from certain users); etc.). When the monitoring and remediation subsystem 216 detects that a device may be behaving anomalously or outside ranges of expected measurements, the subsystem can update a flag or a state of the device indicating the device may require troubleshooting and/or add the device to a remediation interface for further evaluation and possible resolutions as discussed further below.

The monitoring and remediation subsystem 216 can utilize various techniques for identifying devices that perform outside of specified measurement boundaries or that behave anomalously from standard behavior. In some embodiments, an end user can manually place devices into a remediation interface or otherwise mark devices for remediation. For example, the end user may operate a client device connected to the user interface subsystem 206 to search for and/or filter devices by device name, device type, manufacturer, model, network address or network address range, physical location, device owner, tuple information, and so forth, and select devices for migration to the remediation interface.

Alternatively or in addition, the monitoring and remediation subsystem 216 may evaluate network access and security policies or rules for assigning devices to the remediation interface for any failed access attempts or when the devices exceed a specified number of failed access attempts over any time period or over a specified time period. The rules may be defined by an end user and/or automatically defined by and/or derived from the network controller 200; device manufacturers (e.g., via a MUD profile as discussed further below); industry standards groups; vulnerability databases (e.g., Open Source Vulnerability Database (OSVDB), National Vulnerability Database (NVD), Cisco® Vulnerability Database, etc.); DNS, IP address, and MAC address blacklists (e.g., Cisco Talos™ Reputation Center, SpamCop® Blocking List, Spam and Open Relay Blocking System (SORBS), etc.), and other security authorities. The network access and security policies and rules can comprise access control lists (ACLs), security group rules, firewall rules, and the like. Network access and security policies or rules can include whitelist rules (e.g., policies that deny access by default and allow access only if a policy exists to permit the access) and/or blacklist rules (e.g., policies that permit access by default unless a policy exists to prohibit the access).

The monitoring and remediation subsystem 216 may also enact application-based policies for how a specific application, class of applications, or classes of applications can operate in a network, such as rules prohibiting certain applications or websites (e.g., Telnet, BitTorrent, games, social networking, etc.); quality of service (QoS) or quality of experience (QoE) rules; rules regarding average, minimum, and/or maximum network traffic volume, throughput, or other temporal traffic metric, latency, jitter, packet loss, and other errors; and rules regarding application performance (e.g., average, minimum, and/or maximum load, response times, CPU usage, memory usage, disk usage, etc.).

The monitoring and remediation subsystem 216 may also deploy device-based policies for a specific type of device, class of devices, or classes of devices, such as rules relating to operational time periods, including wakeup intervals, expected operation only during business hours, regularly scheduled uploads/downloads, and so forth; operational ranges for network, application/process, and/or device performance (e.g., acceptable or unacceptable ranges for bandwidth/throughput, latency, jitter, packet loss, error, load, response times, computing resource usage, etc.); operational temperature ranges (including ambient temperature or device temperature); operational air quality measures (e.g., acceptable or unacceptable amounts of smoke, carbon monoxide, etc.); operational power ranges (including battery levels); device states (e.g., open/closed or locked/unlocked state for doors, windows, physical locks, etc., which can be absolute states or states lasting for a specified duration and/or states occurring within a particular time of day); and other device-specific information discussed throughout the present disclosure.

In some embodiments, the monitoring and remediation subsystem 216 may utilize machine learning for identifying devices not operating within specified ranges of measurements or acting in an anomalous manner. At a high level, machine learning can involve collecting features (e.g., qualities or characteristics of an object that can define the object in part and may be used to compare the similarities or differences between objects) of data samples or data instances (e.g., IoT devices), building feature vectors or other data structure representations for the data samples or data instances, and applying the feature vector representations to a machine learning model or algorithm to solve problems that may otherwise be intractable for humans to solve, such as determining clusters or classes to which IoT devices belong (e.g., compromised device cluster or class, uncompromised device cluster or class, or a cluster or class somewhere in between these possible states).

Machine learning algorithms can include unsupervised or supervised methods. In unsupervised learning, the input data set may not be pre-labeled, and the monitoring and remediation subsystem 216 can apply the input data set to a machine learning algorithm to learn how devices may be similar to one another and the features that may be especially cogent for distinguishing similarities and differences among the devices. Some examples of unsupervised learning techniques include k-means clustering, hierarchical clustering, density-based clustering, and grid-based clustering, among others.

In k-means clustering, a number of n data points (e.g., devices) are partitioned into k clusters such that each point belongs to a cluster with the nearest mean. The algorithm proceeds by alternating steps, assignment and update. During assignment, each point is assigned to a cluster whose mean yields the least within-cluster sum of squares (WCSS) (e.g., the nearest mean). During update, the new means is calculated to be the centroids of the points in the new clusters. Convergence is achieved when the assignments no longer change. One variation of k-means clustering dynamically adjusts the number of clusters by merging and splitting clusters according to predefined thresholds. The new k is used as the expected number of clusters for the next iteration (e.g., Iterative Self-Organizing Data Analysis Technique (ISODATA)). Another variation of k-means clustering uses real data points (medoids) as the cluster centers (e.g., Partitioning Around Medoids (PAM)).

Hierarchical clustering methods sort data into a hierarchical structure (e.g., tree, weighted graph, etc.) based on a similarity measure. Hierarchical clustering can be categorized as divisive or agglomerate. Divisive hierarchical clustering involves splitting or decomposing “central” nodes of the hierarchical structure where the measure of “centrality” can be based on “degree” centrality, (e.g., a node having the most number of edges incident on the node or the most number of edges to and/or from the node), “betweenness” centrality (e.g., a node operating the most number of times as a bridge along the shortest path between two nodes), “closeness” centrality (e.g., a node having the minimum average length of the shortest path between the node and all other nodes of the graph), among others (e.g., Eigenvector centrality, percolation centrality, cross-clique centrality, Freeman centrality, etc.). Agglomerative clustering takes an opposite approach from divisive hierarchical clustering. Instead of beginning from the top of the hierarchy to the bottom, agglomerative clustering traverses the hierarchy from the bottom to the top. In such an approach, clustering may be initiated with individual nodes and gradually combine nodes or groups of nodes together to form larger clusters. Certain measures of the quality of the cluster determine the nodes to group together at each iteration. A common measure of such quality is graph modularity.

Density-based clustering is premised on the idea that data points are distributed according to a limited number of probability distributions that can be derived from certain density functions (e.g., multivariate Gaussian, t-distribution, or variations) that may differ only in parameters. If the distributions are known, finding the clusters of a data set becomes a matter of estimating the parameters of a finite set of underlying models. Expectation maximization (EM) is an example of density-based clustering, and can involve multiple iterations for finding the maximum likelihood or maximum a posteriori estimates of parameters in a statistical model, where the model depends on unobserved latent variables. The EM iteration alternates between performing an expectation (E) step, which creates a function for the expectation of the log-likelihood evaluated using the current estimate for the parameters, and a maximization (M) step, which computes parameters for maximizing the expected log-likelihood found during the E step. These parameter-estimates are then used to determine the distribution of the latent variables in the next E step.

Grid-based clustering divides a data space into a set of cells or cubes by a grid. This structure is then used as a basis for determining the final data partitioning. Examples of grid-based clustering include Wave Clustering and Statistical Information Grid (STING). Wave clustering fits the data space onto a multi-dimensional grid, transforms the grid by applying wavelet transformations, and identifies dense regions in the transformed data space. STING divides a data space into rectangular cells and computes various features for each cell (e.g., mean, maximum value, minimum value, etc.). Features of higher level cells are computed from lower level cells. Dense clusters can be identified based on count and cell size information.

Supervised learning methods operate on pre-labeled data. The monitoring and remediation subsystem 216 can acquire the pre-labeled data, classified according to predetermined criteria, to learn the model (e.g., extrapolate the features and feature values) for mapping new unclassified devices to one or more classifications. Some examples of supervised learning algorithms include k-nearest neighbor (a variation of the k-means clustering algorithm discussed above), Naïve Bayesian classifiers, boosting, perceptrons and neural networks, decision trees and random forests, and support vector machines (SVMs), among others.

Naïve Bayesian classifiers are a family of probabilistic classifiers based on Bayes' theorem with strong assumption of independence among features. Bayes' theorem posits that the probability of x given that z already exists or has occurred equals the probability of x and z happening together divided by the probability of z. Formally, this can be referred to as the posterior probability density function p(x|z):

p(x|z)=(p(z|x)p(x))/p(z), (Equation 1)

The optimization criterion of Bayes, minimum risk or maximum posterior expectation, is applicable when it is possible to quantify cost if estimates differ from true parameters and the expectation of the cost is acceptable as an optimization criterion. Cost function C(\hat{x}|x): [symbol] ^{M}→ [symbol] ^{N} can represent a true cost. However, it may be difficult to quantify cost accurately and it is oftentimes more practical to select a cost function whose mathematical treatment is not overly complex and to assume that the cost function depends on the difference between the estimated and true parameters, such as by computing the estimation error e=\hat{x}−x. Given these assumptions, some embodiments may utilize the minimum means square error (MMSE) estimator as a Bayesian estimator. MMSE can be formally defined as:

\hat{x}_{MMSE}z=E[x|z]=∫ₓxp(x|z)dx (Equation 2)

Other embodiments may utilize the maximum a posteriori (MAP) estimator as the Bayesian estimator. MAP can be defined as:

$${\hat{x}}_{MAP} z = {argmax}_{x} \{ \frac{p ( z \vert x ) p ( x )}{p ( x )} \} = {argmax}_{x} \{ p ( z \vert x ) p ( x ) \} \qquad ( Equation 3 )$$

Still other embodiments may utilize maximum likelihood estimation (MLE). MLE is based on the observation that in MAP estimation, the peak of p(z|x) is when p(x) is almost constant. This can be especially true if little prior knowledge is available. In these cases, the prior density p(x) does not affect the position of the maximum very much. Discarding p(x) and maximizing the function p(z|x) leads to the MLE:

\hat{x}_{MLE}z=argmaxₓ{p(z|x)} (Equation 4)

Boosting methods attempt to identify a highly accurate hypothesis (e.g., classifier having a low error rate) from a combination of many “weak” hypotheses (e.g., classifiers having substantial error rates). Given a data set comprising samples (e.g., devices) within a class and not within the class and weights based on the difficulty of classifying a sample and a weak set of classifiers, boosting generates and calls a new weak classifier in each of a series of rounds. For each call, the distribution of weights is updated to reflect the importance of samples in the data set for the classification. On each round, the weights of each incorrectly classified sample are increased, and the weights of each correctly classified example is decreased so the new classifier may focus on the difficult samples (e.g., those samples have not been correctly classified). Example implementations of boosting include Adaptive Boosting (AdaBoost), Gradient Tree Boosting, or XGBoost.

Neural networks are inspired by biological neural networks and comprise an interconnected group of functions or classifiers (e.g., perceptrons) that process information using a connectionist approach. Neural networks change their structure during training, such as by merging overlapping detections within one network and training an arbitration network to combine the results from different networks. Some examples of neural network algorithms include the multilayer neural network, the auto associative neural network, the probabilistic decision-based neural network (PDBNN), and the sparse network of winnows (SNOW).

Decision trees use a tree-like graph or model of decisions and their possible consequences. Internal nodes can represent tests on features, branches can represent outcomes of the tests, and leaf nodes can represent a class label. A data sample (e.g., a device) can be walked through the decision tree from root to leaf, and the label of the leaf node is the class for data sample. Some examples of decision tree algorithms include Classification and Regress Trees (CART), Iterative Dichotomiser 3 (ID3), C4.5, and RepTree.

Random forests rely on a combination of decision trees in which each tree depends on the values of a random vector sampled independently and with the same distribution for all trees in the forest. A random forest can be trained for some number of trees t by sampling n cases of the training data at random with replacement to create a subset of the training data. At each node, a number m of the features are selected at random from the set of all features. The feature that provides the best split is used to do a binary split on that node. At the next node, another number m of the features are selected at random and the process is repeated.

SVMs involve plotting data points in n-dimensional space (where n is the number of features of the data points) and identifying the hyper-plane that differentiates classes and maximizes the distances between the data points of the classes (referred to as the margin).

The monitoring and remediation subsystem 216 can generate machine learning models from various sources, including MUD profiles or similar information from device manufacturers, data samples from a single private network, data samples from multiple customer networks, public data sources, and so forth.

The data subsystem 220 can include any data or information, such as management data, statistics, settings, preferences, profile data, logs, notifications, attributes, configuration parameters, endpoint information, network information, and so forth. For example, the network controller 200 can collect network traffic data and other information from managed devices and store this information as part of the data subsystem 220. The data subsystem 220 may also include performance and/or configuration information, and the network controller 200 can use the data subsystem 220 to perform management or service operations for endpoints. The data subsystem 220 may be stored on a storage or memory device on the network controller 200, a separate storage device connected to the network controller 200, or a remote storage device in communication with the network controller 200.

In some embodiments, the data subsystem 220 can integrate data from heterogeneous data streams to provide access to all of the integrated data and to support different modes of access, such as by deploying a data lake, an enterprise data warehouse (EDW), a hybrid data architecture including an EDW and a data lake, a data virtualization architecture, or other multi-model data architecture. The data subsystem 220 can provide optimized views (e.g., data marts, operational data stores, analytic sandboxes, etc.) into the integrated data to support the services of the IoT management system. An EDW is a centralized, enterprise-wide repository comprising historical and current data from enterprise systems. An EDW can be used by business intelligence systems to run various analytical queries, and the EDW can interface with an Online Analytical Processing (OLAP) system to support multi-dimensional analytical queries. A data lake is a large data storage repository that holds a vast amount (e.g., substantially all or all of the data flowing through the network) in its native format until it is needed. A data lake is polymorphous and can include various types of databases or data stores, such as relational databases, key-value stores, document databases, graph databases, column-family databases, object store, file systems, and so forth. A data lake can store data having various structures, including structured data, semi-structured data, and unstructured data. A data lake can also store data in separate physical locations, such as on-premises (e.g., on enterprise-owned or leased property) or off-premises (e.g., within a public cloud) or in memory, disk, tape, or other suitable medium. An EDW and a data lake can be separate complementary storage systems, but a data lake can also incorporate an EDW in some deployments.

In this example, the data subsystem can comprise an IoT device data store 222, a policy data store 224, a telemetry data store 226, and a remediation data store 228. The IoT device data store 222 can store information regarding managed IoT devices, such as an IoT device's name, IP address, MAC address, device type, manufacturer, model, serial number, timestamp of when the device was first detected by the network controller 200, timestamp of when the device was last detected by the network, description, metadata tags, operating system, user, VLAN, geofencing status, and so forth. The policy data store 224 can store network security policies, application policies, device policies, and other rules for managing IoT devices. The policies and rules may be defined by an end user, the network controller 200, a device manufacturer, an industry standards group, a security service provider, and/or other authority. The telemetry data store 226 can store data captured by the telemetry subsystem 210, including network traffic data at various levels of granularity (e.g., packet data, flow data, connection data, session data, etc.) as well as computed statistical information (e.g., bandwidth, throughput, latency, jitter, packet loss, etc.); device and/or application/process data (e.g., CPU usage, memory usage, virtual memory usage, disk space usage, power usage, start time, duration, etc., on a per IoT device basis and/or on a per application/process basis for each IoT device); and/or other device-specific measurement data (e.g., temperature, biotelemetry, motion, etc.). The remediation data store 228 can store data relating to remediation for IoT devices, such as remediation history, device profile information, remediation actions, and so forth.

FIG. 3 illustrates an example of flow diagram of a process 300 for registering an IoT device (e.g., the IoT device 134) to an IoT management system (e.g., the IoT management system 116). One of ordinary skill will understood that, for any processes discussed herein, there can be additional, fewer, or alternative steps performed in similar or alternative orders, or in parallel, within the scope of the various embodiments unless otherwise stated. The process 300 may be performed by an IoT device (e.g., the IoT device 134) or a client device (e.g., the client device 136) registering the IoT device 134 on behalf of the IoT device to the IoT management system 116.

The process 300 may begin with the IoT device initiating a connection to a networking device (e.g., the networking device 132) of an IoT network (e.g., the IoT cloud 130) for the first time or after a specified period of inactivity (e.g., a Dynamic Host Configuration Protocol (DHCP) lease time). The IoT device 134 or the client device 136 can transmit a request 302 (e.g., Link Layer Discovery Protocol (LLDP), Dynamic Host Configuration Protocol (DHCP), 802.1x, etc.) including a MUD uniform request locator (URL).

The process 300 may continue with the networking device 132 extracting the URL, encapsulating the URL in a request 304 (e.g., RADIUS, Diameter, etc.), and transmitting the request 304 to an AAA server (e.g., the AAA subsystem 212). In other embodiments in which the MUD URL may be embedded in a DHCP request, the networking device 132 may instead forward the DHCP request to the AAA subsystem 212.

After receiving the request 304, the AAA subsystem 212 can transmit a request 306 including the URL to a MUD controller (e.g., the MUD controller 214). In some embodiments, the MUD controller may be integrated with the AAA subsystem 212. The MUD controller 214 may transmit a query 308 (e.g., Hypertext Transfer Protocol Secure (HTTPS)) to a device registration system (e.g., the device registration system 142) for a MUD file 310 corresponding to the IoT device 134. In some implementations, the device registration system 142 may include a file server located at the URL for hosting MUD files for the devices of the manufacturer of the IoT device 134, including the MUD file 310.

After verifying that the MUD file 310 was produced by the device manufacturer, the mud controller 214 can retrieve the MUD file 310 from the device registration system 142. In some implementations, the MUD file can be a Yet Another Next Generation (YANG) data model encoded in JavaScript® Notation (JSON) and containing an abstract intent for the IoT device 134.

The MUD controller 214 can translate the abstract intent to a context-specific policy 312, and transmit the policy 312 to the AAA subsystem 212. The AAA subsystem 212 can enforce the policy 312 within the IoT cloud 130, such as by defining and imposing port-based ACLs 314 for the interfaces between the networking device 132 and the IoT device 134. The process 300 may conclude with the networking device 132 providing access 316 to the IoT cloud 130 based on the device manufacturer's intent.

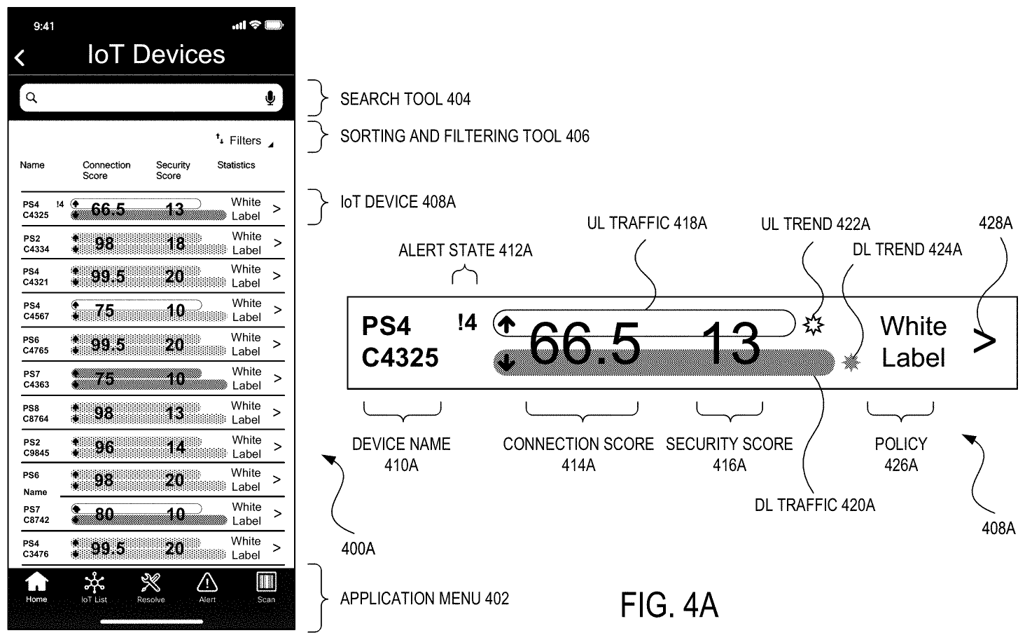

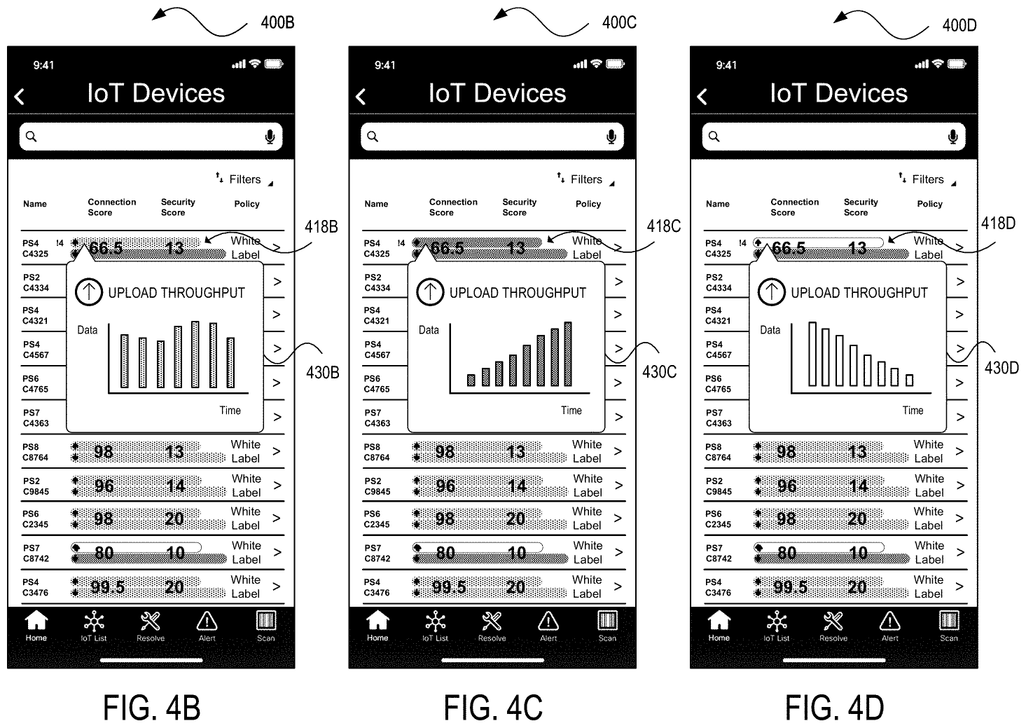

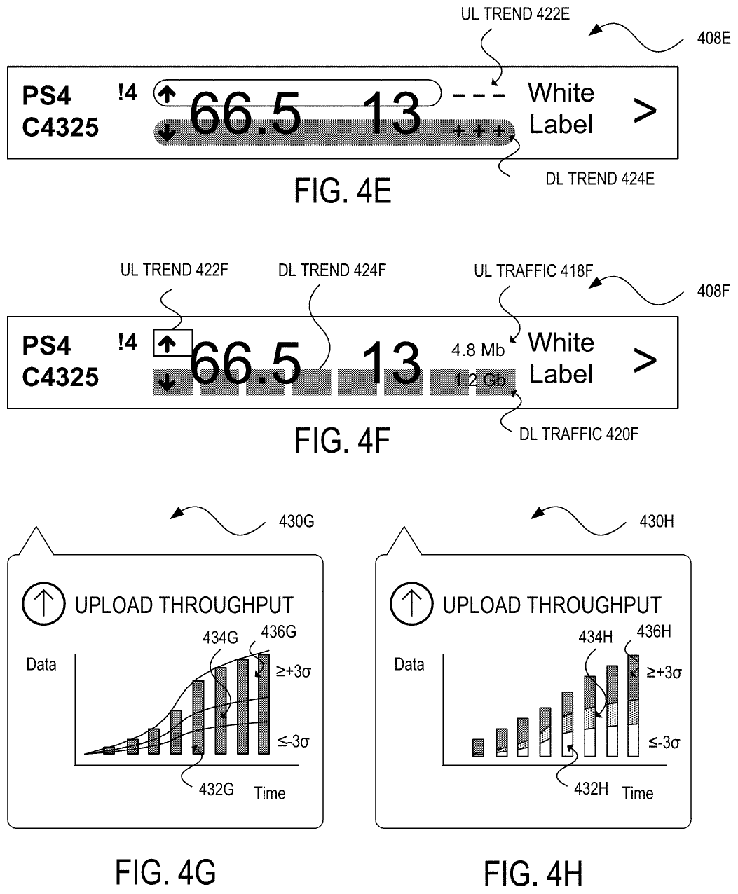

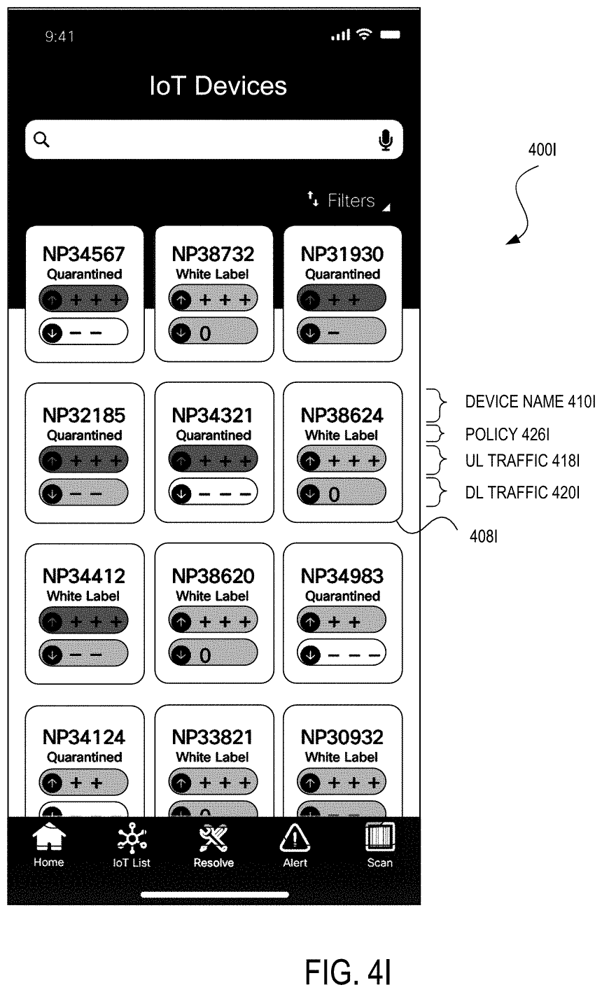

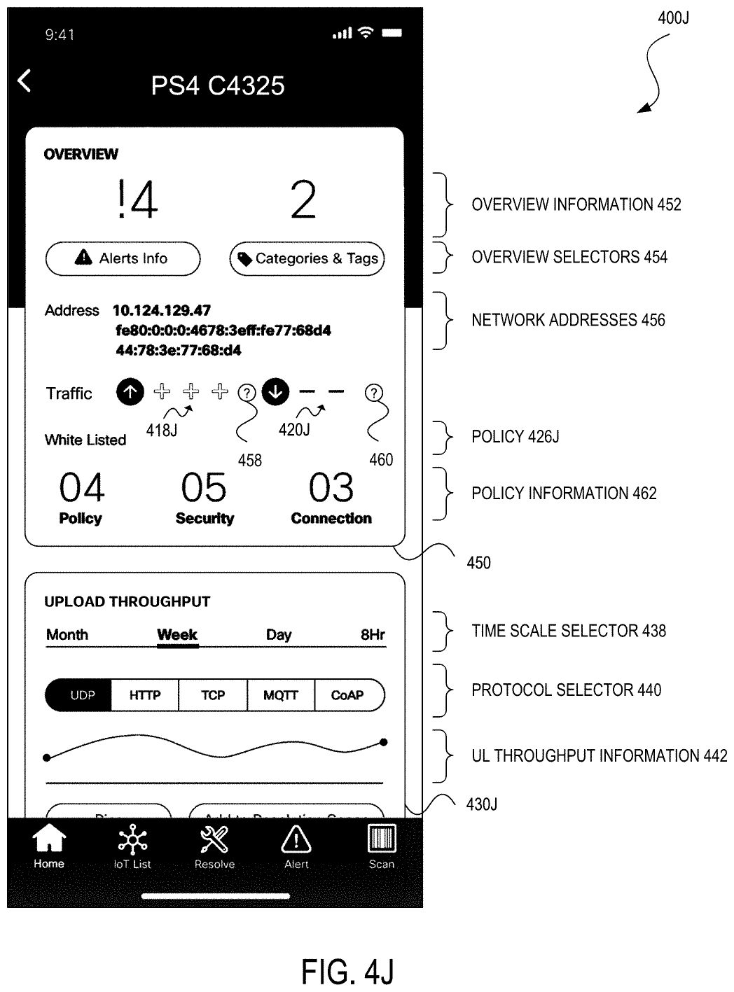

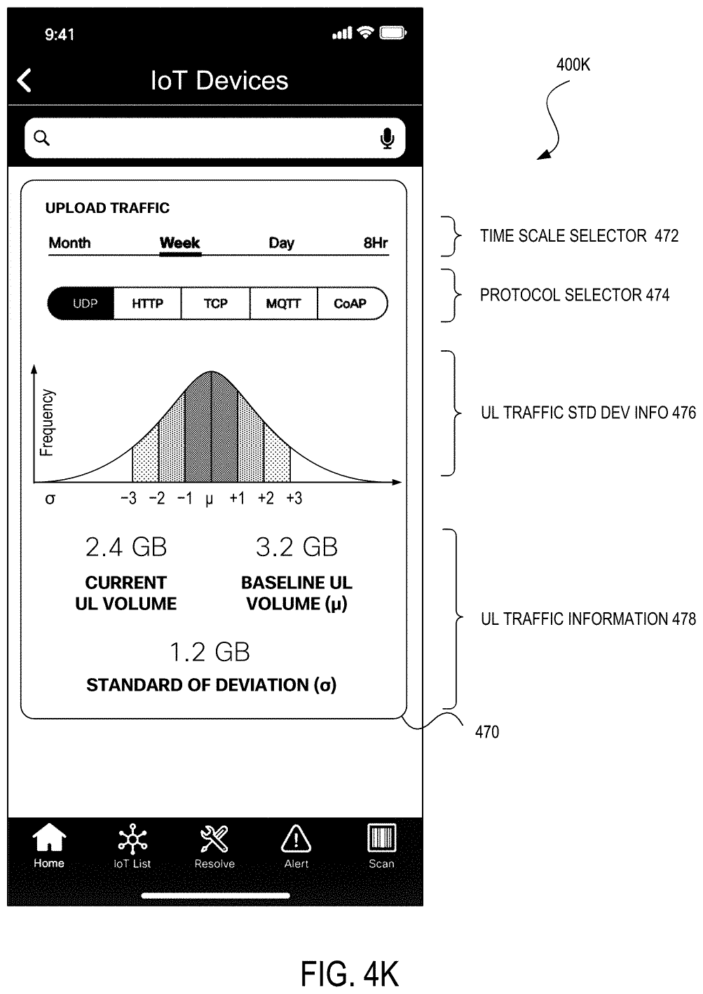

FIGS. 4A-4K illustrate examples of graphical user interfaces for a client application executing on a client device (e.g., the client device 136) that is in communication with an IoT management system (e.g., the IoT management system 116). Although FIGS. 4A-4K show the client application to be a mobile application (e.g., an “app” for a tablet computer, a smart phone, wearable device, or other small form-factor general purpose computing device), the principles disclosed in the present disclosure are widely applicable to client devices of other form factors, including servers, desktops, laptops, televisions, set top boxes, IoT devices, and other computing devices capable of connecting to a WAN (e.g., the WAN 112) and including input/output components to enable an end user to interact with the IoT management system. One of ordinary skill will also understand that the graphical user interfaces of FIGS. 4A-4L are but one example of a user interface for managing IoT devices. Other embodiments may include a fewer number or a greater number of elements.

FIG. 4A illustrates an example of a graphical user interface 400A for a client application of an IoT management system. For example, the graphical user interface 400A can be a home screen or homepage of the client application or the first screen or first webpage displayed to an end user following a login screen or webpage. Alternatively in or addition, the graphical user interface 400A can represent a list view of IoT devices managed by the IoT management system. In this example, the graphical user interface 400A may include an application menu 402, a search tool 404, a sorting and filtering tool 406, and a plurality of list items representing IoT devices in a network managed by the IoT management system, with each list item 408A representing an individual IoT device. As will be appreciated by one of ordinary skill in the art, the client application can also provide various interface elements (e.g., scroll bars) or support various inputs (e.g., swipe gestures) for navigating the IoT device list if the number of list items is greater than what can fit within the display of the client device.

The application menu 402 can enable the end user to navigate through different screens or webpages of the client application, and can include a home button, a button for a list of IoT devices managed by the IoT management system, a resolve button for a remediation user interface for managing IoT devices exhibiting anomalies, an alert button for managing alerts received by the IoT management system, and a scan button to register new IoT devices to the IoT management system.

The search tool 404 can enable the end user to query an IoT device data store (e.g., the IoT device data store 222) based on various metadata fields or characteristics of IoT devices managed by the IoT management system, such as querying by device name, device owner, serial number, device type, manufacturer, model, MAC address, IP address, physical location, current status, policy status, and so forth.

The sorting and filtering tool 406 can enable the end user to sort the order (e.g., natural order or reverse order) of the IoT devices presented in the list view of the graphical user interface 400A, including sorting the IoT devices alphabetically, such as by device name, device owner, device type, manufacturer, model, physical location, status, and other alphabetic characteristics associated with an IoT device; numerically, such as by MAC address, IP address, connection score, security score, upload bandwidth, download bandwidth, number of alerts, number of policies, number of connections, and other numeric characteristics associated with an IoT device; and/or temporally, such as by a time an IoT device was placed in a remediation interface, a time the IoT device was last detected by the IoT management system, a time the IoT first registered with the IoT management system, or other temporal characteristics associated with an IoT device; among other sorting methods. The sorting and filtering tool 406 can also enable the end user to filter (e.g., display only IoT devices that possess a particular characteristic and/or exclude from display IoT devices that do not possess a particular characteristic) the IoT devices presented in the list view of the graphical user interface 400A.

Each list item 408A of the list view of the graphical user interface 400A can represent an IoT device managed by the IoT management system. In this example, each list item 408A can include a device name 410A, a device alert state 412A, a connection score 414A, a security score 416A, an upload traffic indicator 418A, a download traffic indicator 420A, an upload traffic trend indicator 422A, a download traffic trend indicator 424A, and a policy indicator 426A. The device alert state 412A can indicate that the IoT device exhibits one or more anomalies and has been or should be added to a remediation interface or otherwise flagged for remediation. Here, the alert state 412A can also include a numeric indicator representing a number of alerts associated with the IoT device.

The connection score 414A can indicate the network connection strength of the IoT device. Here, the connection score can be a number between 0 and 100 to indicate the connection strength. For example, the IoT management system can measure the connection strength by WiFi signal strength or other wireless technology signal strength. The security score 416A can indicate the security strength of the IoT device. Here, the security score can be a number between 0 and 20 to indicate the security strength. In some embodiments, the IoT management system can use a machine learning subsystem (e.g., the monitoring and remediation subsystem 216) to compute the security score 416A.

The upload traffic indicator 418A can represent multiple dimensions of upload network traffic of the IoT device. In some embodiments, the length of the upload traffic indicator 418A can represent a relative size or volume of traffic (in, e.g., Mb, MB, Gb, GB, Tb, TB, etc.) uploaded by the IoT device over a specified time period (e.g., past hour, past 8 hours, day, week, month, etc.). For example, the length of the bar can be a ratio between the current traffic volume of the IoT device and maximum traffic volume. In some cases, the length of the upload traffic indicator 418A can be relative to a maximum traffic limit as set forth by a network policy, application policy, device policy, user policy, MUD profile or other device profile information, and so forth. In other cases, the length of the upload traffic indicator 418A can be relative to a historical maximum traffic volume uploaded by a specific IoT device or type of IoT device over a specified time period. In still other cases, the length of the upload traffic indicator 418A can be relative to a maximum traffic volume uploaded by any device in the network.

In some embodiments, the color or shade of the upload traffic indicator 418A can represent another dimension of the upload traffic of the IoT device, such as an instantaneous upload throughput of the IoT device or an average upload throughput over a specified time period (e.g., Mb/s, Gb/s, etc.). For instance, Table 1 sets forth example values and a color or shade scheme used for the upload traffic indicator 418A when the μ-value (e.g., mean, median, mode, or expected value) of the instantaneous upload throughput is 4 Mb/s and the standard deviation σ₁ is 1 Mb/s, and the μ-value of the average upload throughput is 2.5 Mb/s and the standard deviation σ₂ is 0.5 Mb/s. In other embodiments, the color or shade of the upload traffic indicator 418A can represent a change in the instantaneous upload throughput or average upload throughput over a specified time period (e.g., Mb/s², Gb/s², etc.). In still other embodiments, other visual indicators may be used to represent throughput (or changes in throughput) or other temporal traffic metrics as discussed throughout the present disclosure.

TABLE 1
Example Values for Throughput

| | Traffic | | Inst. | Avg. | | | |
|---|---|---|---|---|---|---|---|
| Time | Volume | | Through- | Through- | | | |
| Elapsed | (Mb) | | put | put | | | |
| (s) | (Total) | | (Mb/s) | (Mb/s) | σ₁ | σ₂ | Color or Shade |
| 0 | 0 | | 0 | 0 | — | — | — |
| 1 | 1 | (1) | 1 | 1 | −3 | −3 | Blue |
| | | | | | | | (0x0000FF) |
| 2 | 2 | (3) | 2 | 1.5 | −2 | −2 | LightSkyBlue |
| | | | | | | | (0x87CEFA) |
| 3 | 3 | (6) | 3 | 2 | −1 | −1 | Gray |
| | | | | | | | (0x666666) |
| 4 | 4 | (10) | 4 | 2.5 | 0 | 0 | Gray |
| | | | | | | | (0x666666) |
| 5 | 5 | (15) | 5 | 3 | +1 | +1 | Gray |
| | | | | | | | (0x666666) |
| 6 | 6 | (21) | 6 | 3.5 | +2 | +2 | LightPink |
| | | | | | | | (0xFFB6C1) |
| 7 | 7 | (28) | 7 | 4 | +3 | +3 | Red |
| | | | | | | | (0xFF0000) |

In the example of Table 1, blue can represent throughput (or change in throughput) values that are three or more standard deviations less than the μ-value of historical throughputs (or other temporal network traffic metric) (e.g., current throughput≤−3σ), light blue can represent throughput values that are between three and two standard deviations less than the μ-value of historical throughputs (e.g., −3σ<current throughput≤−2σ), gray can represent throughput values that are within two standard deviations from the μ-value of historical throughputs (e.g., −2σ<current throughput<+2σ), pink can represent throughput values that are between two and three standard deviations greater than the μ-value of historical throughputs (e.g., +2σ≤current throughput<+3σ), and red can represent throughput values that are three or more standard deviations greater than the μ-value of historical throughputs (e.g., current throughput≥+3σ). In other embodiments, only throughput values above or below a specified threshold (e.g., three or more standard deviations less than or greater than the μ-value of historical throughputs or current throughput≤3σ and current throughput≥+3σ) may be represented in different colors or shades (e.g., light blue and pink, respectively) and a neutral color (e.g., gray) can represent throughput values within the specified threshold (e.g., within three standard deviations of the μ-value of historical throughputs or −3σ<current throughput≤+3σ). In still other embodiments, different color or shade schemes may be utilized to represent the current upload throughput of the IoT device with respect to the number of standard deviations σ from the μ-value of historical throughputs (or other temporal traffic metric), such as a different color or shade for each standard deviation (e.g., −3σ, −2σ, −1σ, 0, +1σ, +2σ, +3σ, etc.) or different colors or shades for different ranges of standard deviations (e.g., between −3σ and −1σ, between +1σ and +3σ, etc.)

The download traffic indicator 420A can represent multiple dimensions of download network traffic of the IoT device. For example, like the upload traffic indicator 418A, the length of the download traffic indicator 420A can represent a relative size or volume of traffic downloaded by the IoT device over a specified time period and the color or shade of the download traffic indicator 420A can represent the download throughput (or the change in download throughput). In some embodiments, the lengths of the upload traffic indicator 418A and the download traffic indicator 420A may be relative to one another. For example, if the maximum upload throughput of the IoT device is 4 Mb/s and the maximum download throughput of the IoT device is 8 Mb/s, then the length of the upload traffic indicator 418A may be no greater than half the length of the download traffic indicator 420A at any time. In other embodiments, the lengths of the upload traffic indicator 418A and the download traffic indicator 420A may be relative to a maximum upload traffic volume and a maximum download traffic volume, respectively. For example, if the current upload throughput of the IoT device is 2 Mb/s and the maximum upload throughput of the IoT device is 4 Mb/s, and the current download throughput of the IoT device is 4 Mb/s and the maximum download throughput of the IoT device is 8 Mb/s, then the lengths of the upload traffic indicator 418A and the download traffic indicator 420A may be the same or similar (e.g., approximately half-length).

The upload traffic trend indicator 422A and the download traffic trend indicator 424A can represent traffic trends. In this example, the upload traffic trend indicator 422A can denote that the current upload traffic volume is three or more standard deviations less than the μ-value of historical upload traffic volumes (e.g., current upload traffic volume≤−3σ), and the download trend indicator 424A can indicate that the current download traffic volume is three or more standard deviations greater than the μ-value of historical download traffic volumes (e.g., current download traffic volume≥+3σ). In other embodiments, the upload traffic trend indicator 422A and the download traffic trend indicator 424A can represent throughputs (or other temporal network traffic metrics) that are three or more standard deviations less than or greater than the μ-value of historical upload throughputs (or other temporal traffic metric) (e.g., current upload throughput≤−3σ or current upload throughput≥+3σ). In still other embodiments, the upload traffic trend indicator 422A and the download traffic trend indicator 424A can represent more granular traffic statistics with respect to the μ-value of historical network traffic metrics (e.g., −3σ, −2σ, −1σ, +1σ, +2σ, +3σ, etc.), such as discussed with respect to FIG. 4E and elsewhere in the present disclosure.

The policy indicator 426A can denote the current policy or policies applied to the IoT device, such as whether the IoT management system permits access to the network by the IoT device (e.g., “White Label” or “White Listed”); monitors the IoT device with an increased level of scrutiny, such as by capturing and storing the IoT device's traffic for further analysis (e.g., “Copy Snapshot”); temporarily blocks the IoT device from accessing the network (e.g., “Quarantined”); or permanently blocks the IoT device from accessing the network (e.g., “Black Listed”).

Each list item 408A can also include a detailed view selection user interface element 428A to indicate to the end user that the end user can select (e.g., via a virtual or physical pointer) the list item 408A for a detailed view of the IoT device, such as discussed with respect to FIG. 4J and elsewhere in the present disclosure.

FIGS. 4B, 4C, and 4D illustrate examples of graphical user interfaces 400B, 400C, and 400D, respectively, for a client application of an IoT management system. The graphical user interfaces 400B, 400C, and 400D can include upload throughput user interface elements 430B, 430C, and 430D, respectively, which can represent detailed views of upload throughput information (or the change in upload throughput) for a specific IoT device. In this example, the upload throughput user interface elements 430B, 430C, and 430D may be presented in response to a selection of upload traffic indicators 418B, 418C, and 418D, respectively. For example, an end user can tap, double tap, long press, hover over for a specified duration, click, or right-click the upload traffic indicators or perform another selection gesture or selection input associated with the upload traffic indicators to cause the display of the upload throughput user interface elements.

The graphical user interfaces 400B, 400C, and 400D can each indicate a different state of the IoT device based on its upload throughput (or the change in its upload throughput). For instance, the graphical user interface 400B can indicate a normal upload state both by the color or shade of the upload traffic indicator 418B and the bar graph in the upload throughput user interface element 430B. In this example, the color or shade of the upload traffic indicator 418B may be the same or similar to the color or the shade of the bars of the bar graph. Thus, the upload throughput user interface element 430B can operate as a key or legend for the upload traffic indicator 418B as well as convey real-time upload throughput (or change in upload throughput) information for the IoT device. The graphical user interface 400C can represent an upload state in which the IoT device is exhibiting abnormally high upload throughput (or change in upload throughput) as conveyed by both the color or shade of the upload traffic indicator 418C and the bar graph in the upload throughput user interface element 430C. The graphical user interface 400D can represent an upload state in which the IoT device is exhibiting abnormally low upload throughput (or change in upload throughput) as conveyed by both the color or shade of the upload traffic indicator 418D and the bar graph in the upload throughput user interface element 430D. Other embodiments may utilize different visualizations for representing throughput (or change in throughput), such as discussed with respect to FIGS. 4G and 4H and elsewhere in the present disclosure.

FIG. 4E illustrates an example of a graphical user interface element 408E, which can be an alternative implementation for representing a list item corresponding to an individual IoT device managed by an IoT management system via a client application executing on a client device. In this example, the list item 408E can include an upload traffic trend indicator 422E and a download traffic trend indicator 424E. In some embodiments, the number of elements of the traffic trend indicators can correspond to the number of standard deviations σ of the current traffic volume from the μ-value of historical traffic volumes. For example, here, the upload traffic trend indicator 422E comprises 3 minus signs, which can denote that the current upload traffic volume is three or more standard deviations less than the μ-value of historical upload traffic volumes (e.g., current upload traffic≤−3σ). The download traffic trend indicator 424E, on the other hand, comprises 3 plus signs, which can denote that the download traffic is three or more standard deviations greater than the μ-value of historical download traffic volumes (e.g., current download traffic≥+3σ). In other embodiments, the number of elements of the traffic trend indicators can correspond to the number of standard deviations of the current throughput (or change in throughput or other temporal traffic metric) from the μ-value of historical throughputs (or other temporal network traffic metrics).

FIG. 4F illustrates an example of a graphical user interface element 408F, which can be an alternative implementation for representing a list item corresponding to an individual IoT device managed by an IoT management system via a client application executing on a client device. In this example, the list item 408F can include an upload traffic indicator 418F, a download traffic indicator 420F, an upload traffic trend indicator 422F, and a download traffic trend indicator 424F. The upload traffic indicator 418F can set forth the upload traffic volume in numeric form, and the download traffic indicator 420F likewise can set forth the download traffic volume in numeric form. The upload traffic trend indicator 422F can denote the current upload throughput (or change in throughput) using a particular color or shade and/or by the number of graphical elements. For example, one bar or segment can indicate that the current upload throughput is three or more standard deviations less than the μ-value of historical upload throughputs (e.g., current upload throughput≤−3σ), two bars or segments can indicate that the current upload throughput is between two and three standard deviations less than the μ-value of historical upload throughputs (e.g., −39σ<current upload throughput≤−2σ), three bars or segments can indicate that the current upload throughput is between one and two standard deviations less than the μ-value of historical upload throughputs (e.g., −2σ<current upload throughput<μ), four bars or segments can indicate that the current upload throughput is within one standard deviation less than the μ-value of historical upload throughputs (e.g., μ<current upload throughput<+1σ), five bars or segments can indicate that the current throughput is within one standard deviation greater than the μ-value of historical upload throughputs (e.g., μ<current upload throughput<+1σ), six bars can indicate that the current upload throughput is between one and two standard deviations greater than the μ-value of historical upload throughputs (e.g., +1σ≤current upload throughput<+2σ), seven bars or segments can indicate that the current upload throughput is between two and three standard deviations greater than the μ-value of historical upload throughputs (e.g., +2σ≤current upload throughput<+3σ), eight bars or segments can indicate that the current upload throughput is three or more standard deviations greater than the μ-value of historical upload throughputs (e.g., current upload throughput≥+3σ), and so forth.

FIG. 4G illustrates an example of a graphical user interface element 430G, which can be an alternative implementation of a detailed upload throughput user interface element for an IoT device managed by an IoT management system via a client application executing on a client device. In this example, the bars in the detailed upload throughput user interface element 430G can represent current upload throughput over a specified time period while regions between the curves can represent historical upload throughput over a corresponding time period. For example, a region 432G can represent historical upload throughputs that are three or more standard deviations less than the μ-value of historical upload throughputs (e.g., historical upload throughputs≤−3σ), a region 434G can represent historical upload throughputs that are within three standard deviations of the μ-value of historical upload throughputs (e.g. −3σ<historical upload throughputs<+3σ), and a region 436G can represent historical upload throughputs that are three or more standard deviations greater than the μ-value of historical upload throughputs (e.g., historical upload throughputs≥+3σ). One of ordinary skill in the art will appreciate that the detailed upload throughput user interface element 430G may include additional regions, such as regions representing throughputs within one standard deviation of the μ-value of historical throughputs (e.g., −1σ<throughput<μ and μ<throughput<+1σ), regions representing throughputs between one and two standard deviations less than or greater than the μ-value of historical throughputs (e.g., −2σ<throughput≤−1σ and +1σ≤throughput<+2σ), and so forth and/or different regions, such as a region representing throughputs between one and three standard deviations less than the μ-value of historical throughputs (e.g., −3σ≤throughput≤−1σ), a region representing throughputs between one and three standard deviations greater than the μ-value of historical throughputs (e.g., +1σ≤throughput≤+3σ), and so forth.

FIG. 4H illustrates an example of a graphical user interface element 430H, which can be an alternative implementation of a detailed upload throughput user interface element for an IoT device managed by an IoT management system via a client application executing on a client device. In this example, the bars in the detailed upload throughput user interface element 430G can represent current upload throughput while the color or shade can represent historical upload throughput. For example, a first color or shade 432H can represent historical upload throughputs that are three or more standard deviations less than the μ-value of historical upload throughputs (e.g., historical upload throughputs≤−3σ), a second color or shade 434H can represent historical upload throughput within three standard deviations of the μ-value of historical upload throughputs (e.g. −3σ21 historical upload throughputs<+3σ), and a third color or shade 436G can represent historical upload throughputs that are three or more standard deviations greater than the μ-value of historical upload throughputs (e.g., historical upload throughputs≥+3σ). One of ordinary skill in the art will appreciate that throughput visualization may include additional colors or shades, such as colors or shades representing throughputs that are within one standard deviation of the μ-value of historical throughputs (e.g., −1σ<throughput<μ and μ<throughput<+1σ), colors or shades representing throughputs that are between one and two standard deviations less than or greater than the μ-value of historical throughputs (e.g., −2σ<throughputs≤−1σ and +1σ≤throughputs<+2σ), and so forth and/or different colors or shades, such as a color or shade representing throughputs between one and three standard deviations less than the μ-value of historical throughputs (e.g., −3σ≤throughputs≤−1σ), a color or shade representing throughputs between one and three standard deviations greater than the μ-value of historical throughputs (e.g., +1σ≤throughputs≤+3σ), and so forth.

FIG. 41 illustrates an example of a graphical user interface 400I for a client application of an IoT management system, which can be an alternative implementation for representing multiple IoT devices administered by an IoT management system. In this example, the graphical user interface 400I can include a plurality of tiles representing IoT devices in a network managed by the IoT management system, with each tile 4081 representing an individual IoT device. Each tile 408I may include a device name 410I, a policy indicator 426I, an upload traffic indicator 418I, and a download traffic indicator 420I.

The upload traffic indicator 418I can represent multiple dimensions of upload network traffic of the IoT device. In some embodiments, the number of graphical elements of the upload traffic indicator 418I can represent upload traffic volume and the color or shade of the upload traffic indicator 418I can represent upload throughput (or change in throughput) or vice versa (e.g., graphical elements can denote upload throughput and color or shade can denote traffic volume). For example, here, the upload traffic indicator 418I includes three plus signs, which can denote that the current upload traffic volume is three or more standard deviations greater than the μ-value of historical upload traffic volumes (e.g., current upload traffic volume≥+3σ). In other situations, two plus signs can denote that the current upload traffic volume is between two and three standard deviations greater than the μ-value of historical upload traffic volumes (e.g., +2σ≤current upload traffic volume<+3σ), one plus sign can denote that the current upload traffic volume is between one and two standard deviations greater than the μ-value of historical upload traffic volumes (e.g., +1σ≤current upload traffic volume<+2σ), a zero can denote that the current upload traffic is within one standard of deviation less than or greater than the μ-value of historical upload traffic volumes (e.g., −1σ<current upload traffic volume<+1σ), one minus sign can indicate that the current traffic upload volume is between one and two standard deviations less than the μ-value of historical upload traffic volumes (e.g., −2σ<current upload traffic volume≤−1σ), two minus signs can indicate that the current traffic upload volume is between two and three standard deviations less than the the μ-value of historical upload traffic volumes (e.g., −3σ<current upload traffic volume≤−2σ), three minus signs can denote that the current upload traffic volume is three or more standard deviations less than the μ-value of historical upload traffic volumes (e.g., current upload traffic volume≤−3σ), and so forth. The color or shade of the upload traffic indicator 418I can represent current upload throughput (or other temporal network traffic metric) relative to the μ-value of historical upload throughputs (or other temporal network traffic traffics). In this example, dark gray can denote that the current upload throughput is three or more standard deviations greater than the μ-value of historical upload throughputs (e.g., current upload throughput≥+3σ), light gray can denote that the current upload throughput is within three standard deviations of the μ-value of historical upload throughputs (e.g., −3σ<current upload throughput<+3σ), and white can denote that the current upload throughput is three or more standard deviations less than the μ-value of historical upload throughputs (e.g., current upload throughput≤−3σ). Other embodiments may map different colors or shades to the current upload throughput relative to the the μ-value of historical upload throughputs and/or map additional colors or shades to the current upload throughput relative to the μ-value of historical upload throughputs, such as a different shade or color for each standard deviation (e.g., −3σ, −2σ, −1σ, 0, +1σ, +2σ, +3σ, etc.) or different shades or colors for different ranges of standard deviations (e.g., between −3σ and −1σ, between +1σ and +3σ, etc.). In still other embodiments, the number of graphical elements of the traffic indicators 418I and 420I can represent throughputs (or other temporal traffic metrics) over specified time periods, and the colors or shades of the traffic indicators 418I and 420I can represent traffic volumes over specified time periods.

In some embodiments, the graphical user interface 400I can also include one or more stacks of views, panes, cards, containers, widgets, or other user interface elements, with each stack representing a group of IoT devices. The groupings can represent IoT devices corresponding to the same or similar portion of a name (e.g., prefix, infix, postfix, etc.), device type (e.g., fire alarms, security cameras, door locks) or class (e.g., connected vehicles, healthcare devices, industrial equipment, etc.), manufacturer, model, subnet address, physical location, device owner, policies, security score, virus/malware infection, anomalous behavior, and so forth. For example, the IoT management system can utilize machine learning clustering to identify the one or more groups of IoT devices. Selection of a stack of user interface elements can display individual user interface elements within the selected device group and/or one or more stacks of user interface elements representing subgroupings of the selected device group.

FIG. 4J illustrates an example of a graphical user interface 400J for a client application of an IoT management system. For example, the graphical user interface 400J can represent a detailed view of an IoT device managed by the IoT management system, which an end user may navigate to by selecting a detailed view selection user interface element (e.g., the detailed view selection user interface element 428A). The graphical user interface 400J can include one or more views, panes, tiles, cards, containers, widgets, or other user interface elements. In this example, the graphical user interface 400J can include a detailed upload throughput user interface element 430J and an overview user interface element 450.

The detailed upload throughput user interface element 430J can include a time scale selection user interface element 438, a protocol selection user interface element 440, and upload throughput information 442. The time scale selection user interface element 438 can enable an end user to adjust the time scale (e.g., monthly, weekly daily, 8-hour period, etc.) at which upload throughput information is presented within the detailed upload throughput user interface element 430J. The protocol selection user interface element 440 can enable the end user to specify the protocol (e.g., UDP, HTTP, TCP, MQTT, CoAP, etc.) of the IoT device's traffic to be presented within the detailed upload throughput user interface element 430J. The upload throughput information 442 can represent current upload throughput (e.g., as a line graph) according to the time scale specified by the time scale selection user interface element 438 and the protocol specified by the protocol selection user interface element 440. In some embodiments, the upload throughput information 442 can include real-time updates (e.g., updates occurring at a rate exceeding a minimum latency threshold or at a rate of little to no noticeable delay by a human) of upload throughput by the IoT device.

The overview user interface element 450 can comprise overview information 452, overview selection user interface elements 454, network addresses 456, an upload traffic indicator 418J, a detailed upload traffic selection user interface element 458, a download traffic indicator 420J, a detailed download traffic selection user interface element 460, a policy indicator 426J, and policy information 462. The overview information 452 can indicate a number of alerts associated with the IoT device and the number of metadata tags, categories, labels, fields, characteristics, and so forth, attributed to the IoT device. The overview selection user interface elements 454 can enable the end user to drill down for more detailed information regarding the alerts and the metadata tags associated with the IoT device.

The network addresses 456 can include IP addresses (e.g., IPv4 and/or IPv6), MAC addresses (e.g., Extended Unique Identifier (EUI)-48 and/or EUI-64), and/or other unique identifying information of the IoT device (e.g., device name, serial number, etc.).

The upload traffic indicator 418J denote the current upload traffic volume relative to the IoT device's μ-value of historical upload traffic volumes, and the download traffic indicator 420J can denote the current download traffic volume relative to the IoT device's μ-value of historical download traffic volumes. For example, three plus signs can indicate that the current traffic volume is three or more standard deviations greater than the μ-value of historical traffic volumes (e.g., current traffic volume≥+3σ), two plus signs can indicate that the current upload traffic volume is between two and three standard deviations greater than the μ-value of historical traffic volumes (e.g., +2σ≤current traffic volume<+3σ), one plus sign can indicate that the current traffic volume is between one and two standard deviations greater than the μ-value of historical traffic volumes (e.g., +1σ≤current traffic volume<+2σ), 0 can indicate that the current traffic volume is within one standard deviation less than or greater than the μ-value of historical traffic volumes (e.g., −1σ>current traffic volume<+1σ), one minus sign can indicate that the current traffic volume is between one and two standard deviations less than the μ-value of historical traffic volumes (e.g., −2σ<current traffic volume≤−1σ), two minus signs can indicate that the current traffic volume is between two and three standard deviations less than the μ-value of historical traffic volumes (e.g., −3σ<current traffic volume≤−2σ), three minus signs can indicate that the current traffic volume is three or more standard deviations less than the μ-value of historical traffic volumes (e.g., current traffic volume≤−3σ), and so forth. The detailed upload traffic selection user interface element 458 and the detailed download traffic user interface element can enable the end user to respectively view more detailed information regarding upload traffic volume and download traffic volume as further discussed with respect to FIG. 4K and elsewhere in the present disclosure.

The policy indicator 426J can indicate the current network policy or policies applied to the IoT device, such as whether the IoT management system permits access to the network by the IoT device (e.g., “White Label” or “White Listed”); monitors the IoT device with an increased level of scrutiny, such as by capturing and storing the IoT device's traffic for further analysis (e.g., “Copy Snapshot”); temporarily blocks the IoT device from accessing the network (e.g., “Quarantined”); or permanently blocks the IoT device from accessing the network (e.g., “Black Listed”). The policy information 462 can include information regarding the number of application policies applicable to the IoT device, the number of network security policies applicable to the IoT device, and the current number of connections of the IoT device. In some embodiments, the overview user interface element 450 can also include user interface elements to enable the user to drill down for detailed information regarding application policies, network security policies, and connections associated with the IoT device.

In other embodiments, the traffic indicators 418J and 420J may instead denote throughput (or change in throughput) and the graphical user interface 400J may include a user interface element comprising detailed traffic volume information. In still other embodiments, the graphical user interface 400J may include user interface elements (e.g., views, panes, tiles, cards, containers, widgets, etc.) for providing detailed information for both traffic volume and throughput (or change in throughput).

FIG. 4K illustrates an example of a graphical user interface 400K for a client application of an IoT management system. For example, the graphical user interface 400K can represent a detailed view of upload traffic information for an IoT device managed by the IoT management system, which an end user may navigate to by selecting a detailed upload traffic selection interface element (e.g., the detailed upload traffic selection user interface element 458). The graphical user interface 400K can include one or more views, panes, tiles, cards, containers, widgets, or other user interface elements. In this example, the graphical user interface 400K can include a detailed upload traffic user interface element 470.

The detailed upload traffic user interface element 470 can include a time scale selection user interface element 472, a protocol selection user interface element 474, upload traffic standard deviation information 476, and upload traffic information 478. The time scale selection user interface element 472 may operate the same or similarly to the time scale selection user interface element 438, and the protocol selection user interface element 474 may operate the same or similarly to the protocol selection user interface element 440.

The upload traffic standard deviation information 476 can denote the distribution of historical upload traffic volume of the IoT device over a specified time period, including upload traffic volumes that are three or more standard deviations less than the μ-value of historical upload traffic volumes (e.g., traffic volume≤−3σ or approximately 0.1% of values), between two and three standard deviations less than the μ-value of historical upload traffic volumes (e.g., −3σ<current traffic volume≤−2σ or approximately 2.1% of values), between one and two standard deviations less than the μ-value of historical upload traffic volumes (e.g., −2σ<current traffic volume≤−1σ or approximately 13.0% of values), within one standard deviation less than the μ-value of historical upload traffic volumes (e.g., −1σ<current traffic volume<μ or approximately 34.1% of values), within one standard deviation greater than the μ-value of historical upload traffic volumes (e.g., ν<current traffic volume<+1σ or approximately 34.1% of values), between one and two standard deviations greater than the μ-value of historical upload traffic volumes (e.g., +1σ≤current traffic volume<+2σ or approximately 13.0% of values), between two and three standard deviations greater than the μ-value of historical upload traffic volumes (e.g., +2σ≤current traffic volume<+3σ or approximately 2.1% of values), three or more standard deviations greater than the μ-value of historical upload traffic volumes (e.g., current traffic volume≥+3σ or approximately 0.1% of values), and so forth.

The upload traffic information 478 can set forth details regarding the upload traffic of the IoT device, such as the current traffic volume over the specified time period, the baseline or the μ-value of historical traffic volumes over the specified time period, the values of the standard deviations (e.g., −3σ, −2σ, −1σ, 0, +1σ, +2σ, +3σ, etc.) over the specified time period, and so forth.

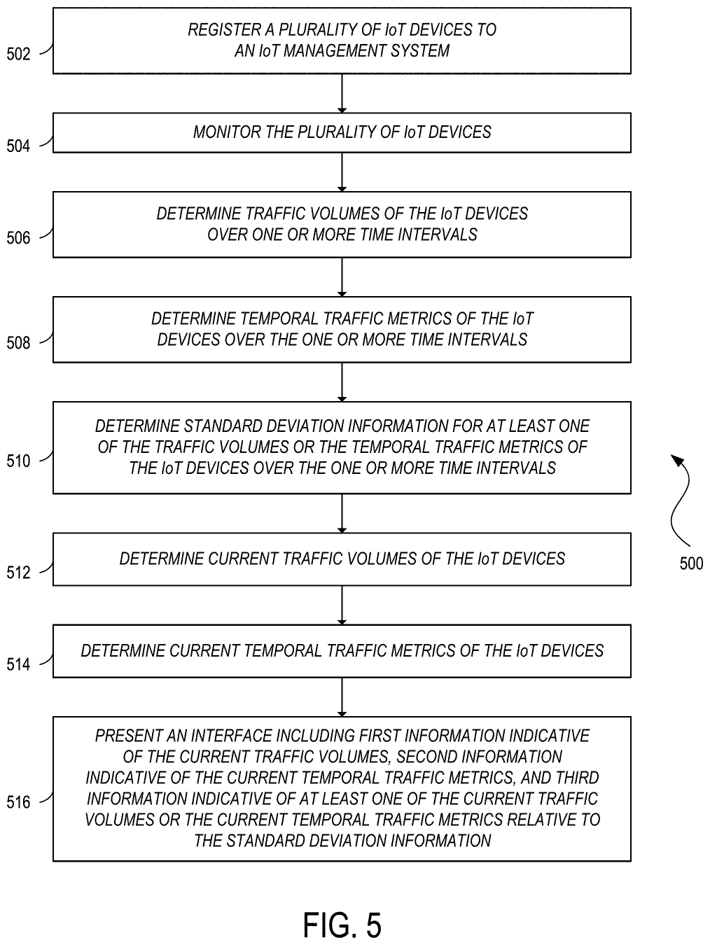

FIG. 5 illustrates an example of a process 500 for computing and presenting network traffic metrics and trends for managing a plurality of IoT devices. The process 500 may be performed in part or entirely by a provider of IoT management services operating a cloud network (e.g., the cloud network 110) or a fog network (e.g., the fog cloud 120), a network controller (e.g., the network controller 200) of a private network (e.g., the IoT cloud 130), an IoT device (e.g., the IoT device 134), a client device (e.g., the client device 136), and so forth.

The process 500 may begin with step 502 in which a plurality of IoT devices are registered to the IoT management system. In some embodiments, this can involve the IoT devices self-registering upon attempting to connect to the private network. In other embodiments, device registration may be initiated by the client device scanning a QR code, bar code, MAC address, serial number, or other unique identifying information or otherwise inputting the unique identifying information and transmitting the unique identifying information to the IoT management system. An example of a device registration process is discussed with respect to FIG. 3.

Once the IoT devices are registered, the IoT management system can monitor the IoT devices for performance, security, and other administrative issues at step 504. Monitoring can include tracking and analyzing network traffic data for the IoT devices at various levels of granularity (e.g., packet, flow, connection, session, etc.) and/or computing aggregate traffic data (e.g., bandwidth, throughput, delay, latency, jitter, data loss and other errors, etc.). In some embodiments, monitoring can also include tracking and analyzing general device information or application/process information (e.g., CPU usage, memory usage, disk usage, power usage, user information, etc.), device-specific or application/process-specific information (e.g., temperature data, unlocked/locked state, audio data, video data, etc.), and other information discussed throughout the present disclosure.

In some embodiments, the IoT management system can monitor the IoT devices with respect to network security policies or rules (e.g., ACLs, security group rules, firewall rules, etc.). For example, if an IoT device attempts to access a portion of the network to which it is not allowed at any time, the IoT management system can mark or flag the device for remediation and move the device to a remediation interface. In other embodiments, the IoT management system can monitor the number of dropped or rejected packets/flows originating from the IoT device, and upon the number of dropped or rejected traffic exceeding a threshold amount, add the device to the remediation interface. In some of these cases, the threshold amount may include a temporal condition (e.g., a limit of the amount of dropped or rejected traffic in a day that is reset each day).

Alternatively or in addition, the IoT management system may monitor the IoT devices with respect to application-based policies (e.g., forbidden applications, network domain names, IP addresses, and the like; QoS or QoE rules; rules regarding average, minimum, and/or maximum network traffic volume, throughput, or other temporal traffic metric, latency, jitter, packet loss, and other errors; rules regarding average, minimum, and/or maximum load, response time, computing resource usage, etc.). For example, if an IoT device transmits CoAP traffic but in an abnormally high volume in contravention to an application/process policy limiting CoAP traffic for a specific application, the IoT management system can add the device to the remediation interface.

Alternatively or in addition, the IoT management system may evaluate the IoT devices with respect to device-based policies or rules (e.g., operational time periods; expected ranges for bandwidth/throughput, network latency, jitter, packet loss, error, load, response times, computing resource usage, etc.; operating temperature range; operating air quality range; device state; and so forth). For example, if an IoT device wakes up at abnormal intervals despite device policies specifying a time period when the IoT device may operate, the IoT management system can add the IoT device to a remediation state.

Alternatively or in addition, the IoT management system may monitor the IoT devices with respect to device profiles, which may be provided by device manufacturers, industry standards groups, device profile databases, and the like. For example, a MUD profile for the IoT management system can include a set of specifications for operational ranges and behaviors of an IoT device. The IoT management system can analyze the IoT device's behavior based on the MUD profile, and mark the device for remediation if the IoT deviates from the specifications set forth in the MUD profile. In one embodiment, an IoT device can announce an organizationally unique identifier (OUI) during registration but may fail to transmit a MUD URL, or the device may transmit an OUI that does not correspond to the device based on the OUI or the device's traffic. In these instances, the IoT management system can flag the device for remediation.

Alternatively or in addition, the IoT management system may utilize machine learning for monitoring the IoT devices, such as using clustering or classification machine learning models for identifying whether the IoT devices are exhibiting anomalies (e.g., behaving or otherwise exhibiting characteristics similar to compromised devices or not behaving or otherwise not exhibiting characteristics similar to uncompromised devices). For example, if an IoT device with known keep alive and firmware update patterns begins downloading a larger firmware update than expected according to a machine learning model for that device or starts sending traffic consistent with a machine learning model for clustering or classifying traffic of a compromised device, the IoT management system can add the device to the remediation interface.

During the course of monitoring the IoT devices, the IoT management system can track various network traffic metrics for each IoT device over various intervals of time, such as over one-hour periods, two-hour periods, four-hour periods, eight-hour periods, 12-hour periods, daily periods, weekly periods, bi-weekly periods, monthly periods, and so forth. For example, the IoT management can calculate at step 506 the network traffic volumes of the IoT devices over the various intervals. In some embodiments, the IoT management system can distinguish between upload network traffic volumes and download network traffic volumes of each IoT device. In some embodiments, the IoT management system can also calculate at step 508 temporal network traffic metrics of the IoT devices over the same time intervals. Temporal network traffic metrics can include upload and/or download throughputs (e.g., traffic volume per unit of time, such as Mb/s, MB/s, Gb/s, GB/s, etc.), changes in upload and/or download throughputs (e.g., throughput per unit of time, such as Mb/s², MB/s², Gb/s², GB/s², etc.), latencies, jitter, data loss, errors, and other network traffic metrics relative to time.

Once the IoT management system has accumulated network traffic metrics for each IoT device or class of IoT devices, the process 500 can proceed to step 510 in which the IoT management system can calculate standard deviation information for the IoT devices. For example, the IoT management system can determine the distribution of values for a particular network traffic metric (e.g., traffic volume, throughput, change in throughput, etc.), including the μ-value (e.g., mean, median, mode, or expected value of historic values) of the particular network traffic metric; the standard deviation σ of the particular network traffic metric; and the values that are three or more standard deviations less than the μ-value (e.g., values≤−3σ or approximately 0.1% of values), between two and three standard deviations less than the μ-value (e.g., −3σ<values≤−2σ or approximately 2.1% of values), between one and two standard deviations less than the μ-value (e.g., −2σ<values≤−1σ or approximately 13.0% of values), within one standard deviation less than the μ-value (e.g., −1σ<values<μ or approximately 34.1% of values), within one standard deviation greater than the μ-value (e.g., μ<values<+1σ), between one and two standard deviations greater than the μ-value (e.g., +1σ≤values <+2σ or approximately 13.0% of values), between two and three standard deviations greater than the μ-value (e.g., +2σ≤values<+3σ or approximately 2.1% of values), three or more standard deviations greater than the μ-value (e.g., values≥+3σ or approximately 0.1% of values), and so forth.

The IoT management system can continuously monitor the IoT devices and track the network metrics over the various intervals of time, including current network metrics over a specified time period. For example, at step 512, the IoT management system can calculate the current network traffic volumes of the IoT devices, and at step 514, the IoT management system can calculate the current temporal network traffic metrics (e.g., throughputs, change in throughputs, etc.) of the IoT devices.

The process 500 can conclude at step 516 in which the IoT management system can present (e.g., transmit to the client application for display on a screen of the client device) an interface including first information indicative of the current network traffic volumes, second information indicative of the current temporal network traffic metrics, and third information indicative of at least one of the current network traffic volumes or the current temporal network traffic metrics relative to the standard deviation information calculated at step 510. For example, the first information can be represented graphically, such as a bar relative to a maximum traffic volume as illustrated by the upload traffic indicators 418A, 418B, 418I, 418J, and so forth or the download traffic indicators 420A, 420I, 420J, and so forth, or by a line graph, such as illustrated by the graphical user interface element 442; alphanumerically, such as shown by the upload traffic indicator 418F, the download traffic indicator 420F, the upload traffic information 468, and so forth; by color or shade; and by other approaches discussed throughout the present disclosure.

The second information can also be represented graphically, such as illustrated by the upload throughput user interface elements 430B, 430C, 430D, 430G, 430H, 430J, and so forth, or by a line graph, such as illustrated by the upload throughput information 442; alphanumerically; by color or shade, such as illustrated by the upload traffic indicators 418A, 418B, 418C, 418D, 418F, 418I, 418J, and so forth or the download traffic indicators 420A, 420I, 420J, and so forth; and by other approaches discussed throughout the present disclosure.

The third information can also be represented graphically, such as illustrated by the upload traffic trend indicators 422A, 422E, 422F, and so forth, the download traffic trend indicators 424A, 424E, 424F, and so forth, the traffic indicators 418I, 418J, 420I, 420J, and so forth, the upload throughput user interface elements 430G and 430H, or the upload traffic standard deviation information 466; alphanumerically, such as shown by the upload traffic information 468; by color or shade, such as illustrated by upload throughput user interface element 430H; and by other approaches discussed throughout the present disclosure.

In this manner, various embodiments of the present disclosure can enable an end user to immediately understand the network traffic volume, throughput (or change in throughput or other temporal network traffic metric), and the trends associated with traffic volume and/or throughput (or change in throughput or other temporal network traffic metrics) of multiple IoT devices. This information can be presented efficiently and compactly so as to provide information for more IoT devices than conventional systems, and on smaller form-factor client devices (e.g., tablets, smart phones, etc.), which has heretofore not yet been achieved by conventional systems. In addition, various embodiments of the present disclosure are capable of providing detailed information for managing IoT devices by simple, intuitive gestures or other inputs.

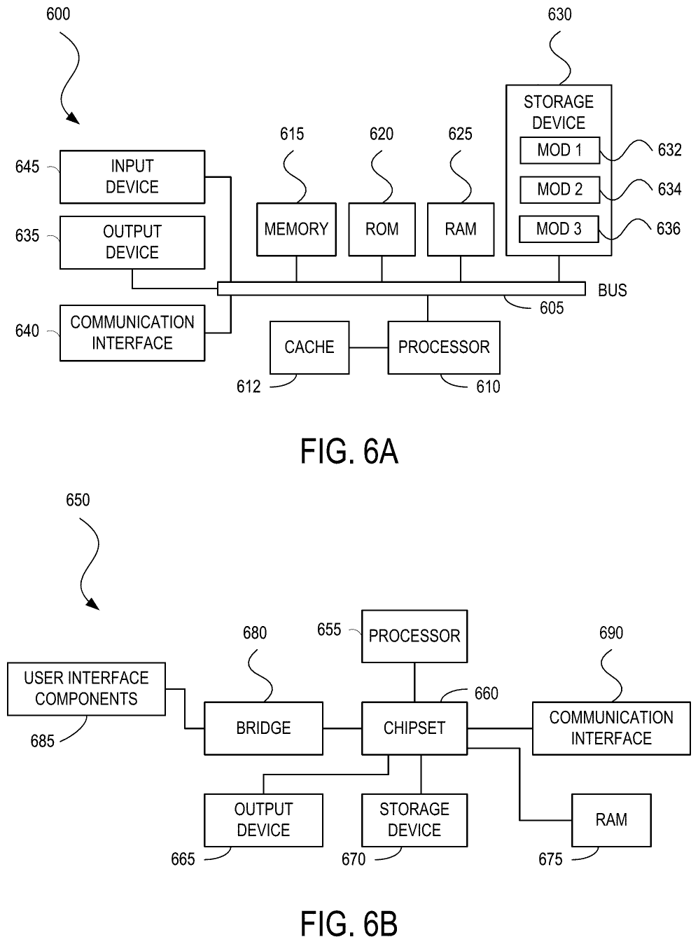

FIG. 6A and FIG. 6B illustrate systems in accordance with various embodiments. The more appropriate system will be apparent to those of ordinary skill in the art when practicing the various embodiments. Persons of ordinary skill in the art will also readily appreciate that other systems are possible.

FIG. 6A illustrates an example of a bus computing system 600 wherein the components of the system are in electrical communication with each other using a bus 605. The computing system 600 can include a processing unit (CPU or processor) 610 and a system bus 605 that may couple various system components including the system memory 615, such as read only memory (ROM) 620 and random access memory (RAM) 625, to the processor 610. The computing system 600 can include a cache 612 of high-speed memory connected directly with, in close proximity to, or integrated as part of the processor 610. The computing system 600 can copy data from the memory 615, ROM 620, RAM 625, and/or storage device 630 to the cache 612 for quick access by the processor 610. In this way, the cache 612 can provide a performance boost that avoids processor delays while waiting for data. These and other modules can control the processor 610 to perform various actions. Other system memory 615 may be available for use as well. The memory 615 can include multiple different types of memory with different performance characteristics. The processor 610 can include any general purpose processor and a hardware module or software module, such as module 1 632, module 2 634, and module 3 636 stored in the storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction with the computing system 600, an input device 645 can represent any number of input mechanisms, such as a microphone for speech, a touch-protected screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing system 600. The communications interface 640 can govern and manage the user input and system output. There may be no restriction on operating on any particular hardware arrangement and therefore the basic features here may easily be substituted for improved hardware or firmware arrangements as they are developed.

The storage device 630 can be a non-volatile memory and can be a hard disk or other types of computer readable media which can store data that are accessible by a computer, such as magnetic cassettes, flash memory cards, solid state memory devices, digital versatile disks, cartridges, random access memory, read only memory, and hybrids thereof.

As discussed above, the storage device 630 can include the software modules 632, 634, 636 for controlling the processor 610. Other hardware or software modules are contemplated. The storage device 630 can be connected to the system bus 605. In some embodiments, a hardware module that performs a particular function can include a software component stored in a computer-readable medium in connection with the necessary hardware components, such as the processor 610, bus 605, output device 635, and so forth, to carry out the function.

FIG. 6B illustrates an example architecture for a chipset computing system 650 that can be used in accordance with an embodiment. The computing system 650 can include a processor 655, representative of any number of physically and/or logically distinct resources capable of executing software, firmware, and hardware configured to perform identified computations. The processor 655 can communicate with a chipset 660 that can control input to and output from the processor 655. In this example, the chipset 660 can output information to an output device 665, such as a display, and can read and write information to storage device 670, which can include magnetic media, solid state media, and other suitable storage media. The chipset 660 can also read data from and write data to RAM 675. A bridge 680 for interfacing with a variety of user interface components 685 can be provided for interfacing with the chipset 660. The user interface components 685 can include a keyboard, a microphone, touch detection and processing circuitry, a pointing device, such as a mouse, and so on. Inputs to the computing system 650 can come from any of a variety of sources, machine generated and/or human generated.

The chipset 660 can also interface with one or more communication interfaces 690 that can have different physical interfaces. The communication interfaces 690 can include interfaces for wired and wireless LANs, for broadband wireless networks, as well as personal area networks. Some applications of the methods for generating, displaying, and using the technology disclosed herein can include receiving ordered datasets over the physical interface or be generated by the machine itself by the processor 655 analyzing data stored in the storage device 670 or the RAM 675. Further, the computing system 650 can receive inputs from a user via the user interface components 685 and execute appropriate functions, such as browsing functions by interpreting these inputs using the processor 655.

It will be appreciated that computing systems 600 and 650 can have more than one processor 610 and 655, respectively, or be part of a group or cluster of computing devices networked together to provide greater processing capability.

For clarity of explanation, in some instances the various embodiments may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Some examples of such form factors include general purpose computing devices such as servers, rack mount devices, desktop computers, laptop computers, and so on, or general purpose mobile computing devices, such as tablet computers, smart phones, personal digital assistants, wearable devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer-implemented method comprising:
determining network traffic volumes of a plurality of Internet of Things (IoT) devices over one or more time intervals;
determining temporal network traffic metrics of the plurality of IoT devices over the one or more time intervals;
determining standard deviation information for at least one of the network traffic volumes or the temporal network traffic metrics over the one or more time intervals;
determining current network traffic volumes of the plurality of IoT devices;
determining current temporal network traffic metrics of the plurality of IoT devices; and
presenting an interface including first information indicative of the current network traffic volumes, second information indicative of the current temporal network traffic metrics, and third information indicative of at least one of the current network traffic volumes or the current temporal network traffic metrics relative to the standard deviation information.

2. The computer-implemented method of claim 1, further comprising:
determining upload traffic volumes of the plurality of IoT devices over the one or more time intervals; and
determining download traffic volumes of the plurality of IoT devices over the one or more time intervals.

3. The computer-implemented method of claim 1, further comprising:
determining upload throughputs of the plurality of IoT devices over the one or more time intervals; and
determining download throughputs of the plurality of IoT devices over the one or more time intervals.

4. The computer-implemented method of claim 1, further comprising:
determining at least one of changes in throughputs, amounts of latency, amounts of jitter, amounts of data loss, or amounts of errors of the plurality of IoT devices over the one or more time intervals.

5. The computer-implemented method of claim 1, further comprising:
receiving a selection input associated with the second information indicative of the current temporal network traffic metrics of an IoT device of the plurality of IoT devices; and
presenting detailed temporal network traffic metrics of the IoT device.

6. The computer-implemented method of claim 1, further comprising:
determining a μ-value from at least one of a mean, a median, a mode, or an expected value from a set of values of a network metric of an IoT device of the plurality of IoT devices;
determining a first subset of the values that are one or more standard deviations less than the μ-value; and
determining a second subset of the values that are one or more standard deviations greater than the μ-value.

7. The computer-implemented method of claim 1, wherein the first information indicative of the current network traffic volumes of an IoT device of the plurality of IoT devices is represented as a bar having length that is a ratio between a current network traffic volume of the IoT device and a maximum network traffic volume.

8. The computer-implemented method of claim 1, wherein the second information indicative of the current temporal network traffic metrics of an IoT device of the plurality of IoT devices is represented as a color or a shade associated with a number of standard deviations of a current throughput of the IoT device.

9. The computer-implemented method of claim 1, wherein the third information indicative of at least one of the current network traffic volumes or the current temporal network traffic metrics relative to the standard deviation information of an IoT device of the plurality of IoT devices is represented as a number of graphical elements corresponding to a number of standard deviations of at least one of a current network traffic volume or a current temporal network traffic metric of the IoT device from a μ-value of at least one of the network traffic volumes or the temporal network traffic metrics of the IoT device.

10. The computer-implemented method of claim 1, further comprising:
determining a group of IoT devices from among the plurality of IoT devices based on one or more shared characteristics among the group; and
presenting a stacked representation of the group of IoT devices in the interface.

11. The computer-implemented method of claim 1, further comprising:
receiving registration information for an IoT device of the plurality of IoT devices via a client device scanning a machine-readable code of the IoT device.

12. The computer-implemented method of claim 1, further comprising:
receiving a request including a uniform resource locator to a machine usage description for an IoT device of the plurality of IoT devices; and
registering the IoT device based on the request.

13. A system, comprising:
one or more processors;
at least one computer-readable storage medium having stored therein instructions which, when executed by the one or more processors, cause the system to:
determine network traffic volumes of a plurality of Internet of Things (IoT) devices over one or more time intervals;
determine temporal network traffic metrics of the plurality of IoT devices over the one or more time intervals;
determine standard deviation information for at least one of the network traffic volumes or the temporal network traffic metrics over the one or more time intervals;
determine current network traffic volumes of the plurality of IoT devices;
determine current temporal network traffic metrics of the plurality of IoT devices; and
present an interface including first information indicative of the current network traffic volumes, second information indicative of the current temporal network traffic metrics, and third information indicative of at least one of the current network traffic volumes or the current temporal network traffic metrics relative to the standard deviation information.

14. The system of claim 13, further comprising instructions which when executed further cause the system to:
determine upload traffic volumes of the plurality of IoT devices over the one or more time intervals; and
determine download traffic volumes of the plurality of IoT devices over the one or more time intervals.

15. The system of claim 13, further comprising instructions which when executed further cause the system to:
determine upload throughputs of the plurality of IoT devices over the one or more time intervals; and
determine download throughputs of the plurality of IoT devices over the one or more time intervals.

16. The system of claim 13, further comprising instructions which when executed further cause the system to:
determine at least one of changes in throughputs, amounts of latency, amounts of jitter, amounts of data loss, or amounts of errors of the plurality of IoT devices over the one or more time intervals.

17. A non-transitory computer-readable storage medium having stored therein instructions which, when executed by one or more processors of a system, cause the system to:
determine network traffic volumes of a plurality of Internet of Things (IoT) devices over one or more time intervals;
determine temporal network traffic metrics of the plurality of IoT devices over the one or more time intervals;
determine standard deviation information for at least one of the network traffic volumes or the temporal network traffic metrics over the one or more time intervals;
determine current network traffic volumes of the plurality of IoT devices;
determine current temporal network traffic metrics of the plurality of IoT devices; and
present an interface including first information indicative of the current network traffic volumes, second information indicative of the current temporal network traffic metrics, and third information indicative of at least one of the current network traffic volumes or the current temporal network traffic metrics relative to the standard deviation information.

18. The non-transitory computer-readable storage medium of claim 17, wherein the first information indicative of the current network traffic volumes of an IoT device of the plurality of IoT devices is represented as a bar having length that is a ratio between a current network traffic volume of the IoT device and a maximum network traffic volume.

19. The non-transitory computer-readable storage medium of claim 17, wherein the second information indicative of the current temporal network traffic metrics of an IoT device of the plurality of IoT devices is represented as a color or a shade associated with a number of standard deviations of a current throughput of the IoT device.

20. The non-transitory computer-readable storage medium of claim 17, wherein the third information indicative of at least one of the current network traffic volumes or the current temporal network traffic metrics relative to the standard deviation information of an IoT device of the plurality of IoT devices is represented as a number of graphical elements corresponding to a number of standard deviations of at least one of a current network traffic volume or a current temporal network traffic metric of the IoT device from a μ-value of at least one of the network traffic volumes or the temporal network traffic metrics of the IoT device.
